(19) United States
(12) Patent Application Publication
(10) Pub. No.: US 2009/0305883 A1
(43) Pub. Date: Dec. 10, 2009

(54) DEFLUORIDATION OF WATER

(75) Inventors: Sadhana Rayalu, Nehru Marg (IN); Nitin Labhsetwar, Nehru Marg (IN); Sanjay Kamble, Nehru Marg (IN); Rajat S. Ghosh, Pittsburgh, PA (US)

Correspondence Address: INTELLECTUAL PROPERTY, ALCOA TECHNICAL CENTER, BUILDING C, 100 TECHNICAL DRIVE, ALCOA CENTER, PA, 15069-0001, US

(73) Assignee: Alcoa Inc., Pittsburgh, PA (US)

(21) Appl. No.: 12/481,433

(22) Filed: Jun. 9, 2009

Related U.S. Application Data
(60) Provisional application No. 61/060,020, filed on Jun. 9, 2008.

(30) Foreign Application Priority Data
Nov. 18, 2008 (US) PCT/US2008/083919

(51) Int. Cl. B01J 20/04; B01J 20/30; B01J 20/08

(52) U.S. Cl. 502/400

(57) ABSTRACT

Bio-ceramic compositions for removing fluoride from water, and methods for making the same are disclosed. The bio-ceramic composition may comprise alumina, calcium oxide, sulfur, and/or carbon. The bio-ceramic composition may be produced from at least one natural media, such as chitin or eggshell membrane. The bio-ceramic composition may realize an initial fluoride adsorption capacity, in water, of at least about 5 mg/g.

### CROSS-REFERENCE TO RELATED APPLICATION

This U.S. patent application claims priority to PCT Patent Application No. PCT/US08/83919, filed Nov. 18, 2008, entitled “DEFLUORIDATION OF WATER”, and U.S. Provisional Patent Application No. 61/060,020, filed Jun. 9, 2008, and entitled “SYSTEMS, METHODS AND APPARATUS FOR DEFLUORIDATION OF WATER”, each of which are incorporated herein by reference in their entirety. This patent is also related to PCT Patent Application No. PCT/US09/46779, filed Jun. 9, 2009, entitled “DEFLUORIDATION OF WATER”.

### BACKGROUND

Water can contain various contaminants. One such contaminant is fluoride. Often it is useful to remove fluoride from water so as to improve the purity of the water so as avoid, for example, fluorosis.

### SUMMARY OF THE DISCLOSURE

The instant disclosure relates to composition, systems, methods and apparatus for removal of dissolved free and complex fluoride from water, such as drinking water, surface water, storm water, wastewater, non-potable water, and the like.

In one aspect, a bio-ceramic adsorbent is provided, the bio-ceramic adsorbent being at least as effective (if not more effective) than activated alumina in removing fluoride from water. As used herein, bio-ceramic adsorbent means an adsorbent having both an amorphous phase and a crystalline phase and which is produced from at least one natural media, and often from at least two natural media. In one embodiment, the natural media comprises at least one naturally occurring polymer (e.g., acetyl glucosamine). In one embodiment, the natural media includes a nitrogenous carbon source. In one embodiment, the natural media includes a carbon-based backbone and at least one of an acetyl group and an amino group bonded to the carbon-based backbone. In one embodiment, the acetyl group is an acetyl-amino group (e.g., —NH—C═O—CH3). In one embodiment, the natural media comprises at least one egg product, such as eggshell and/or eggshell membrane. In one embodiment, the natural media comprises chitin. In one embodiment, the adsorbent is produced from at least one alum (i.e., a hydrated aluminum sulfate, such as any of the hydrated variants of Al₂(SO₄)₃, including Al₂(SO₄)₃·16H₂O or AlK(SO4)₂·12H₂O). In one embodiment, the ad produced from at least one calcium support (e.g., CaCO₃, CaSO₄). In one embodiment, the calcium support is another natural media, such as eggshell. Any combination of the above ingredients may be used to produce the bio-ceramic adsorbent. In one embodiment, at least one egg product and chitin is used to produce the bio-ceramic adsorbent. Since the bio-ceramic adsorbent is based on natural media, it may provide for a non-toxic removal of fluoride for water. Furthermore, since the bio-ceramic adsorbent is stable (e.g., resistant to leaching and capable of removing fluoride without production of a residual sludge waste), the bio-ceramic adsorbent may not alter total the dissolved solids, taste and/or or odor of the water.

In one approach, the bio-ceramic adsorbent comprises a mixture of metal oxides, sulfur and/or carbon. In one embodiment, the adsorbent comprises alumina, calcium oxide, carbon and sulfur. In one embodiment, the adsorbent comprises a first phase and a second phase. In one embodiment, the first phase is a crystalline phase. In one embodiment, the second phase is an amorphous phase. In some of these embodiments, the crystalline phase may be an alumina crystalline phase. That is, in some embodiments, the alumina may be at least partially in crystalline form, such as alpha-alumina, beta-alumina and/or gamma alumina. In one embodiment, the alumina is a mixture of alpha-alumina and beta-alumina. In some embodiments, the amorphous phase is transitional alumina. In some embodiments, the majority of alumina of the bio-ceramic adsorbent is transitional alumina. In some embodiments, the majority of the alumina of the bio-ceramic adsorbent is transitional alumina, and at least some alpha-alumina and/or beta-alumina is present (e.g., about less than 1 wt. %, each).

In one embodiment, the bio-ceramic adsorbent comprises calcium aluminates. In one embodiment, the bio-ceramic adsorbent comprises carbon promoted alumina. In one embodiment, the bio-ceramic adsorbent comprises carbon promoted CaO. In one embodiment, the bio-ceramic adsorbent comprises calcium sulphate. In one embodiment, the bio-ceramic adsorbent comprises carbon promoted calcium aluminates. In one embodiment, crystallites may be present (e.g. of one or more of these materials). In one embodiment, the crystallite size may be less than 1 micron. In one embodiment, the presence of protein of the natural media (e.g. amino acids such as glutamine, cysteine and asparagine, to name a few) facilitates (e.g., limits) production of crystallites of less than 1 micron in size. In one embodiment, the bio-ceramic adsorbent comprises at least one of substituted calcium aluminate and unsubstituted calcium aluminate. In one embodiment, the bio-ceramic adsorbent comprises at least one of substituted calcium or aluminum salts.

In one approach, the bio-ceramic adsorbent comprises 15-65 wt. % of a first metal oxide (e.g., alumina), 10-40 wt. % of a second metal oxide (e.g., CaO), 5-20 wt. % sulfur, and 1-5 wt. % carbon. It will be appreciated that the above percentages may not test at 100% as some of the carbon and/or sulfur may be in non-elemental form. In one embodiment, at least some of the sulfur is in the form of sulfates. In one embodiment, at least some of the carbon is in the form of carbonates. In one embodiment, the bio-ceramic adsorbent comprises filler/impurities. In one embodiment, the bio-ceramic adsorbent comprises up to about 5 wt. % filler/impurities. In one embodiment, the filler/impurities comprise at least one of sodium, nitrogen and/or silicon.

In one approach, the bio-ceramic adsorbent is at least produced from eggshell membrane and includes 45-65 wt. % alumina, 10-20 wt. % calcium oxide, 5-15 wt. % sulfur, 1-5 wt. % carbon, and up to about 5 wt. % impurities.

In one approach, the bio-ceramic adsorbent is produced from chitin and includes 15-35 wt. % alumina, 20-40 wt. % calcium oxide, 5-20 wt. % sulfur, 1-5 wt. % carbon, and up to about 5 wt. % impurities.

In one approach, the bio-ceramic adsorbent is a regenerable adsorbent. In one embodiment, the bio-ceramic adsorbent is capable of regeneration after adsorbing fluoride, and the adsorbent retains at least about 40% of its original adsorption capacity after regeneration. In other embodiments, the bio-ceramic adsorbent is capable of regeneration after adsorbing fluoride, and the adsorbent retains at least about 50%, or at least about 60%, or at least about 80%, or at least about 90% of its original adsorption capacity after regeneration. In one embodiment, the bio-ceramic adsorbent is capable of regeneration after adsorbing fluoride, and the adsorbent retains a majority of its crystalline structure after regeneration. In one embodiment, the bio-ceramic adsorbent is regenerated via a metal-containing solution, such as one comprising alum. In one embodiment, the bio-ceramic adsorbent is regenerated via another metal chloride (e.g., AlCl₃).

In one approach, the bio-ceramic adsorbent has a better fluoride adsorption capacity than activated alumina. In one embodiment, the bio-ceramic adsorbent has a fluoride adsorption capacity of at least about 5 mg/g (e.g., a breakthrough adsorption capacity). In other embodiments, the bio-ceramic adsorbent has a fluoride adsorption capacity of at least about 8 mg/g, or at least about 10 mg/g, or at least about 15 mg/g, or at least about 20 mg/g. In some embodiments, these fluoride adsorption capacities are breakthrough adsorption capacities. In one embodiment, the water comprises a fluoride concentration of not greater than 100 mg/liter. In one embodiment, the water comprises a fluoride concentration of about 50-60 ppm. In one embodiment, the equilibrium fluoride adsorption capacity is at least 30 mg/g. In one embodiment, the equilibrium water fluoride adsorption capacity is not greater than 60 mg/g. In one embodiment, the equilibrium water fluoride adsorption capacity is in the range of at least 38-50 mg/g.

In one embodiment, the bio-ceramic is more selective than activated alumina. In one embodiment, the bio-ceramic adsorbent is able to achieve the above-noted fluoride removal capacity rates even in the presence of sulfate anions, such as sulfate levels of at least about 500 mg/L, or at least about 1000 mg/L, or at least about 2000 mg/L, or at least about 5000 mg/L, or even at least about 10,000 mg/L. In one embodiment, the bio-ceramic adsorbent is able to achieve the above-noted fluoride removal capacity rates even in the presence of other anions, such as one or more of chloride, carbonate, or bicarbonate anions, to name a few. In one embodiment, the bio-ceramic adsorbent is able to achieve the above-noted fluoride removal capacity rates even in the presence of chloride anions, such as chloride levels of at least about 100 mg/L, or at least about 250 mg/L, or at least about 500 mg/L, or at least about 750 mg/L, or at least about 1000 mg/L, or at least about 2000 mg/L, or at least about 3000 mg/L, or at least about 4000 mg/L, or even at least about 5,000 mg/L. In one embodiment, the bio-ceramic adsorbent is able to achieve the above-noted fluoride removal capacity rates in the pH range of 4 and 9. In one embodiment, the bio-ceramic adsorbent is in insensitive to pH shifts in the pH range of 5 to 8, or is in insensitive to pH shifts in the pH range of 4 to 9, or even is in insensitive to pH shifts in the pH range of 3 to 11.

In one approach, the bio-ceramic adsorbent has a relatively low specific surface area. In one embodiment, the bio-ceramic adsorbent has a specific surface area in the range of from at least about 1 m² per gram, or at least about 5 m² per gram, to not greater than about 10 m² per gram, or not greater than about 20 m² per gram, or not greater than 25 m² per gram, or not greater than about 30 m² per gram. In one embodiment, the bio-ceramic adsorbent has a bulk density of at least about 1.00 g/cm³, such as at least about 1.1 g/cm³. In some embodiments, the bio-ceramic adsorbent has a bulk density of not greater than about 1.3 g/cm³.

In one approach, the bio-ceramic adsorbent is in the form of a particulate. In one embodiment, the bio-ceramic adsorbent is produced from eggshell membrane. In this embodiment, the bio-ceramic adsorbent may have an average particle size (d₅₀) of at least about 20 microns. In some of these embodiments, the bio-ceramic adsorbent may have an average particle size (d₅₀) of not greater than about 35 microns. In some of these approaches, the bio-ceramic adsorbent has an average particle size in the range of 20-30 microns. In some of these embodiments, 90% of the particles are smaller than 100 microns. In another embodiment, the bio-ceramic adsorbent is produced from chitin, and the produced particulate has a particle size range of 20-250 microns.

In some embodiments, bio-ceramic adsorbent particulate is included in a granulated media. This granulated media may have a density in the range of 0.6-0.8 g/cm³ (e.g., about 0.7 g/cm³). This granulated media may have an average size (d₅₀) in the range of 600-800 microns (e.g., about 700 microns), and with at least about 80% of the media having an average size of at least about 500 microns.

The bio-ceramic adsorbent may be produced via combination of one, two or more natural media, in the presence of a metal oxide, and in suitable ratios and solvents, followed by, in no particular order, agitation, drying, calcining, washing and/or grinding. As described above, in one embodiment, the metal oxide is alumina. Other metal oxides, such as calcium oxides, may be utilized. The metal ions may bond to the natural media via, for example, chelation.

In one embodiment, a method for making a bio-ceramic adsorbent includes the steps of (i) preparing a liquid mixture (e.g., a slurry or suspension) comprising at least one natural media and at least one natural metal oxide support, and (ii) recovering bio-ceramic particulate material from the liquid mixture. The preparing step may include combining alum, at least one natural media, and a natural metal oxide support in a solvent. In one embodiment, the natural media is eggshell membrane. In one embodiment, the natural media is chitin. In one embodiment, the natural metal oxide support is a calcium-containing support, such as eggshell (e.g., in particulate form). After the preparing step, a bio-ceramic particulate material may be recovered from the liquid mixture via one or more drying, calcining, grinding and/or washing steps.

In one embodiment, the bio-ceramic adsorbent may be characterized as a biogenic membrane induced supported metal oxide. The biogenic membrane may comprise modified ceramic and non ceramic materials by incorporation of metal salts. In one embodiment, the bio-ceramic adsorbent may be synthesized using eggshell (ES) and at least one of eggshell membrane (ESM) and chitin in combination with one or more metal salts. In one embodiment, the bio-ceramic adsorbent is prepared by chemically modifying ES, ESM, or chitin or modifying any combination thereof via one or more metal salts. Other useful natural media include those having a membrane.

The bio-ceramic adsorbent may be relatively stable when in contact with water. For example, the bio-ceramic adsorbent may be resistant to leaching of metals into the water. As used herein, leaching means movement of a metal element from the bio-ceramic adsorbent into the water. It is believed that bio-ceramic adsorbent is resistant to leaching due to the immobilization of the metal ions in the matrix of the adsorbent though the mechanism of formation of the bio-ceramic adsorbent (e.g., via chelation). The bio-ceramic adsorbent may be resistant to crushing, which may assist in facilitating effective mass transfer by maintaining the available surface area of the adsorbent.

The bio-ceramic adsorbent may realize fluoride adsorption at predetermined hydraulic loading rates. In one embodiment, the bio-ceramic adsorbent may realize the above-noted fluoride removal rates at a hydraulic loading rate in the range of 0.5-1.0 gpm per square foot.

The bio-ceramic adsorbent may be relatively economically feasible to produce. For example, since the bio-ceramic adsorbent is produced from natural media and other low cost materials, the cost of the raw bio-adsorbent materials may be relatively low. Furthermore, the processes associated with the production of the bio-ceramic adsorbent may be relatively non-intensive, further lending to the economic feasibility of bio-ceramic adsorbent.

While the term “adsorbent”, “adsorbing”, “sorbent” and the like may be used herein, it is to be understood, that these terms refer to the process of removing fluoride from water, irrespective of whether the actual removal occurs via adsorption, absorption, substitution, or a combination thereof.

Also, while the adsorbent has been disclosed as being useful in terms of defluoridation, it is anticipated that the adsorbent may find utility in removal of other contaminants from water, such as removal of other anions (e.g., cyanide, nitrates, phosphates), arsenic, heavy metals and organic pollutants. When used to remove organic pollutants, the bio-ceramic adsorbent may be considered to have anti-microbial properties.

### BRIEF DESCRIPTION OF THE DRAWINGS

FIG. 1a illustrates one embodiment of a method for producing a bio-ceramic absorbent comprising eggshell membrane.

FIG. 1b illustrates further embodiments of the method of FIG. 1a.

FIG. 1c illustrates further embodiments of the method of FIG. 1a.

FIG. 2 illustrates one embodiment of a method for producing a bio-ceramic absorbent utilizing eggshell membrane.

FIG. 3 is a table illustrating the effect of the modification of various process parameters associated with the production of a bio-ceramic absorbent comprising eggshell membrane.

FIG. 4 is a flowchart illustrating one embodiment of a method for producing a bio-ceramic absorbent comprising chitin.

FIG. 5 is a table illustrating the effect of modification of various process parameters associated with the production of a bio-ceramic absorbent comprising chitin.

FIG. 6 illustrates a particle size distribution of a bio-ceramic absorbent comprising eggshell membrane.

FIG. 7 is an x-ray diffraction scan of a bio-ceramic absorbent comprising eggshell membrane.

FIG. 8 illustrates the effect of absorbent dose on uptake of fluoride removal from simulated wastewater.

FIG. 9 is a graph illustrating the potential Freundlich model of a bio-ceramic absorbent comprising eggshell membrane.

FIG. 10 is a graph illustrating the applicability of Langmuir absorption isotherm for bio-ceramic absorbent comprising eggshell membrane.

FIG. 11 is a graph illustrating the performance of a bio-ceramic absorbent comprising eggshell membrane versus activated alumina.

FIG. 12 is a graph illustrating the performance of a bio-ceramic absorbent comprising eggshell membrane versus activated alumina.

FIG. 13 is a graph illustrating the fluoride removal performance of a bio-ceramic absorbent comprising eggshell membrane in the presence of various amounts of sulfate anions.

FIG. 14 is a graph illustrating the fluoride removal performance of a bio-ceramic absorbent comprising eggshell membrane in the presence of various amounts of sulfate anions.

FIG. 15 is a graph illustrating the fluoride removal performance of activated alumina.

FIG. 16 is a graph illustrating the fluoride removal performance of a bio-ceramic absorbent comprising eggshell membrane versus activated alumina over a varying range of pH.

FIG. 17 is a graph comparing the fluoride removal performance of a bio-ceramic absorbent comprising eggshell membrane versus activated alumina in an industrial wastewater.

FIG. 18 is a graph comparing the fluoride removal performance of a bio-ceramic absorbent comprising eggshell membrane versus activated alumina in an industrial wastewater.

FIG. 19 is a graph illustrating the effect of adsorbent dose on kinetics of fluoride uptake from industrial wastewater utilizing a bio-ceramic absorbent comprising eggshell membrane.

FIG. 20 is a graph illustrating the effect of adsorbent dose on kinetics of fluoride uptake from industrial wastewater utilizing a bio-ceramic absorbent comprising eggshell membrane.

FIG. 21 is a graph illustrating the kinetics for removal of fluoride from industrial wastewater utilizing a bio-ceramic absorbent comprising eggshell membrane and activated alumina.

FIG. 22 is a schematic illustration of one embodiment of a breakthrough column apparatus utilized in testing bio-ceramic absorbents.

FIG. 23 is a graph illustrating a breakthrough curve for a bio-ceramic absorbent comprising eggshell membrane.

FIG. 24 is a graph illustrating a breakthrough curve for activated alumina.

FIG. 25 is a graph illustrating a regeneration curve for an ESM-A-1 adsorbent in continuous mode (column experiment).

FIG. 26 is a graph illustrating batch-to-batch adsorption rates of a chitin based adsorbent.

FIG. 27 is a graph illustrating breakthrough curves for a chitin based adsorbent.

FIG. 28 is a graph illustrating breakthrough curves for CBA-1, ESM-A-1 and activated alumina adsorbents in industrial wastewater.

FIG. 29 is a graph illustrating breakthrough curves for CBA-1, ESM-A-1 and activated alumina adsorbents in industrial wastewater.

FIG. 30 is a graph illustrating breakthrough curves for CBA-1, ESM-A-1 and activated alumina adsorbents in industrial wastewater.

FIG. 31 is a graph illustrating the effect of pH on uptake of fluoride on a CBA-1 adsorbent from simulated wastewater.

FIG. 32 is a graph illustrating the effect of sulfate concentration on uptake of fluoride on a CBA-1 adsorbent from simulated wastewater.

FIG. 33 is a graph illustrating one embodiment of the effect of sulfate concentration on uptake of fluoride on A CBA-1 adsorbent from simulated wastewater

FIG. 34a is schematic view illustrating the chemical structure of chitin.

FIG. 34b is a schematic view illustrating one embodiment of a bio-ceramic adsorbent produced from chitin.

FIG. 34c is a schematic view illustrating one embodiment of using the bio-ceramic adsorbent to precipitate CaF.

FIG. 34d is a schematic view illustrating using the bio-ceramic adsorbent to attract fluoride ions via substituted alumina.

FIG. 35a is an SEM illustrating a chitin bio-ceramic adsorbent comprising aluminum salt.

FIG. 35b is an SEM illustrating irregularly shaped aluminum particles with agglomerates of small particles adhered on the surface of an eggshell media.

FIG. 35c is an SEM illustrating an adsorbent after contact with a fluoride-containing water.

### DETAILED DISCLOSURE

Reference will now be made to the accompanying figures, which at least assist in illustrating various pertinent features of the instant disclosure.

As noted above, a bio-ceramic adsorbent may be used to treat water comprising fluoride. The bio-ceramic adsorbent may remove dissolved free and/or complex fluoride from water. For example, high fluoride containing wastewater may be generated during aluminum smelting operations. This wastewater may contain high concentration of other anions and cations making fluoride removal difficult. More problematic is that these wastewaters may contain high amounts of both fluoride (e.g., ˜15-200 mg/L) and dissolved sulfates (e.g., 300-40,000 mg/L). The presence of high sulfate concentrations is generally the main constituent interfering with fluoride removal. Typical characteristics of industrial waters are given in Table 1, below.

TABLE 1
Typical characteristics of industrial waters

| Analytes | Typical composition range | |
|---|---|---|
| Dissolved F | 15-200 | mg/L |
| Dissolved SO₄²⁻ | 300-40,000 | mg/L |
| Ph | 6-8 | s.u. |
| Chlorides | 200-300 | mg/L |
| Na | 10-30 | g/L |
| Ca, Mg | 10-100 | mg/L |
| Alkalinity, total | 100-900 | mg/L |
| Alkalinity, bi-carbonate | 900 | mg/L |
| TDS | 40 | g/L |
| TSS | 50-300 | mg/L |

It may be useful to reduce fluoride in industrial waters (and other types of waters) to about 5-10 mg/L. To this end, the instant disclosure provides novel and unique bio-ceramic adsorbents capable of removing fluoride from water.

### Eggshell Membrane Adsorbents

In one embodiment, the bio-ceramic adsorbent is an eggshell membrane (ESM) based adsorbent. The chemical composition (by weight) of eggshell is generally about calcium carbonate (94%), magnesium carbonate (1%), calcium phosphate (1%) and organic matter (4%). The eggshell generated from food processing and manufacturing plants may include calcium carbonate (eggshell) and eggshell membrane (ESM). The ESM resides between the egg white (albumen) and the inner surface of the eggshell. There are two shell membranes around the egg—a thick outer membrane attached to the shell and a thin inner membrane. The total thickness of these two membranes is approximately 100 nm. Each of these membranes is composed of protein fibers that are arranged so as to form a semi-permeable membrane. Therefore, the ESM possesses an intricate lattice network of stable and water-insoluble fibers and has high surface area. The by-product eggshell represents approximately 11% of the total weight (≈60 g) of an egg.

The data in Table 2, below, provide the BET surface area, total pore volume, densities and porosity of eggshell and eggshell membrane particles.

TABLE 2
Main pore properties of eggshell and eggshell membrane particles

| | BET surface | Total pore vol. | True density | Particle density | Particle |
|---|---|---|---|---|---|
| | area | (Vₜ) | ρₛ | (ρₚ) | porosity |
| Sample | (m²/g) | (cm³/g) | (g/cm³) | (g/cm³) | (εₚ) |
| Eggshell | 1.023 ± 0.339 | 0.0065 ± 0.0025 | 2.532 ± 0.021 | 2.491 | 0.0162 |
| Eggshell | 1.294 ± 0.424 | 0.0063 ± 0.0016 | 1.358 ± 0.001 | 1.346 | 0.0088 |
| membrane | | | | | |

The pore properties between eggshell and eggshell membrane are similar. Particle density is calculated by as follows: ρₚ=1/[Vt+(1/ρₛ)]. Particle porosity is calculated as follows: εₚ=1−(ρₚ/ρₛ). The average and standard deviation are based on two measurements.

ESM may be employed in raw or soluble form. The properties of raw ESM (e.g., shape, size and/or thickness) may not be readily controllable. Therefore, soluble eggshell membrane protein (SEP), which can be formed into various shapes, sizes and thicknesses, may be more useful. Water-soluble eggshell membrane protein may be prepared by either (i) treatment of raw ESM in a 3:1 mixture of 1.5M NaOH/ethanol for 3 h at 50° C., or (ii) performic acid oxidation followed by pepsin digestion.

The results of an amino acid and a chemical composition analysis of raw ESM and SEP are summarized in Tables 3 and 4, below. The compositions are similar.

TABLE 3
Amino acid compositions (wt %) of raw ESM and SEP

| Amino acid | Raw ESM | SEP |
|---|---|---|
| Asp | 7.05 | 5.62 |
| Thr | 4.80 | 4.12 |
| Ser | 4.32 | 3.69 |
| Glu | 9.98 | 10.01 |
| Pro | 9.34 | 15.31 |
| Gly | 5.20 | 4.53 |
| Ala | 2.26 | 2.62 |
| Cys | 4.10 | 0.24 |
| Val | 5.30 | 4.86 |
| Met | 3.32 | 3.21 |
| Ile | 2.61 | 2.65 |
| Leu | 3.65 | 3.66 |
| Tyr | 1.87 | 2.27 |
| Phe | 1.35 | 1.45 |
| His | 2.97 | 2.60 |
| Lys | 2.98 | 2.53 |
| Arg | 5.93 | 6.11 |
| Trp | 1.80 | 1.50 |

TABLE 4
Chemical composition of raw ESM and SEP calculated from XPS spectra

| Sample | C (%) | N (%) | O (%) | S (%) |
|---|---|---|---|---|
| Raw ESM | 70.09 | 13.59 | 14.47 | 1.85 |
| SEP | 67.82 | 14.49 | 14.16 | 3.53 |

Production of ESM-Based Adsorbent

Broadly stated, a method of producing ESM-based adsorbents (and other natural media-based adsorbents) may include the steps of combining ESM with a metal oxide support material, and recovering an ESM-based adsorbent. The combining step generally includes preparing a liquid mixture (e.g., a slurry and/or suspension) including the ESM and the metal oxide support, and agitating the liquid mixture for a sufficient time to allow binding between the ESM material and the metal oxide support. In some embodiments, a metal salt (e.g., alum) may be dissolved in the liquid mixture to supplement the amount of metal present in the adsorbent. In some embodiments, this metal salt is a different metal than the metal oxide support. The recovering step generally includes at least one of drying, calcining, grinding and/or washing steps, or multiples thereof.

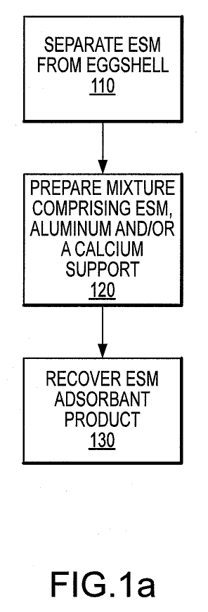

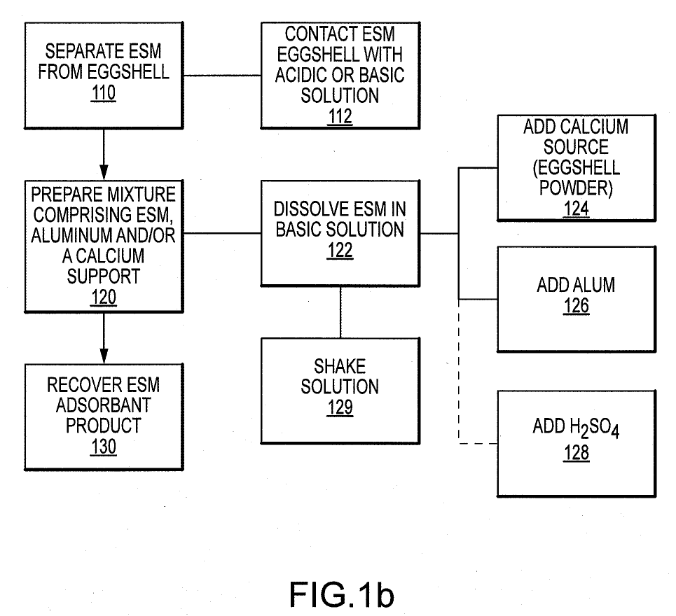

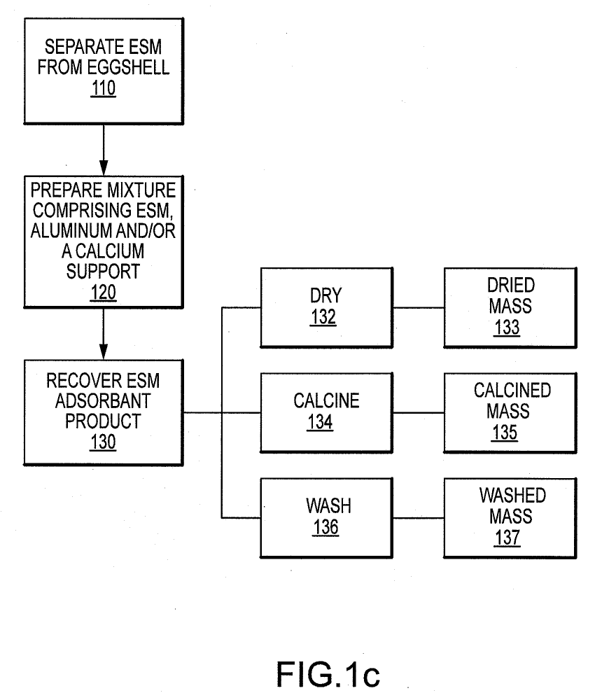

One embodiment of a method for producing an ESM-based adsorbent is illustrated in FIG. 1a. The method 100 may include the steps of (i) separating the ESM from the eggshell (110), (ii) preparing a liquid mixture comprising ESM, aluminum and/or a calcium support material (120) such as eggshell powder, and (iii) recovering ESM adsorbent product (130), among other steps.

With respect to the separating step (110), and with reference now to FIG. 1b, the ESM may be separated from the eggshell via an acidic or basic solution (112), although other methods may be used. As provided above, ESM generally contains amino acids, such as cysteine, which undergo reductive cleavage of disulphide linkage resulting in separation of ESM from the eggshell during these types of treatments.

With respect to the preparing step, and with continued reference to FIG. 1b, the separated ESM may be combined in a liquid mixture with aluminum and/or calcium (120). In one embodiment, the separated ESM may be dissolved in a basic solution (122) (e.g., to a pH of >13) and a calcium source, such as eggshell powder, may be added to the solution comprising the ESM (124). Next, as noted above, an aluminum salt, such as alum, may be combined with the ESM solution (126). Concentrated sulfuric acid may be also used so that the solution achieves a pH in the range of 2-4 (e.g., 3-3.5) (128). On addition of alum and sulfuric acid, the pH reduction may result in partial dissolution of calcite. Calcium ions may be released from the ESM under acidic conditions provided by the alum. The amino, amido and/or carboxyl constituents in ESM have may have an affinity for cations, and may selectively bind aluminum and calcium ions. The solution may be agitated (129) for a prolonged period (e.g., at least about 8 hours) to complete the reaction of aluminum and calcium with ESM.

With respect to the recovering ESM adsorbent product step (130), and with reference now to FIG. 1c, after the preparing step, the product may be recovered via one or more drying (132), calcination (134), and/or washing steps (136). In one approach, after the combining step (120), the combined media is dried to produce a dried mass (133). In one embodiment, a suspension comprising the ESM is dried. During the drying (132), precipitation and crystallization of the product may occur. It is believed that, during drying, an interwoven structure of Ca and Al nanocrystallites (e.g., sulfated versions of Ca and Al nanocrystallites), by virtue of interwoven structure of ESM as a templating agent, may occur. ESM is generally composed of protein fibers and possesses an intricate lattice network of stable and water-insoluble fibers. The composition of the fibers may include about 95% protein, which facilitates adsorption of polycations.

After drying (132), the dried mass (133) may be calcined (134) (e.g., from about 200-600° C., such as from 400-500° C.) under controlled conditions to produce a calcined mass (135). The calcining step may result in a carbonized composite of calcium oxide/calcite and alumina.

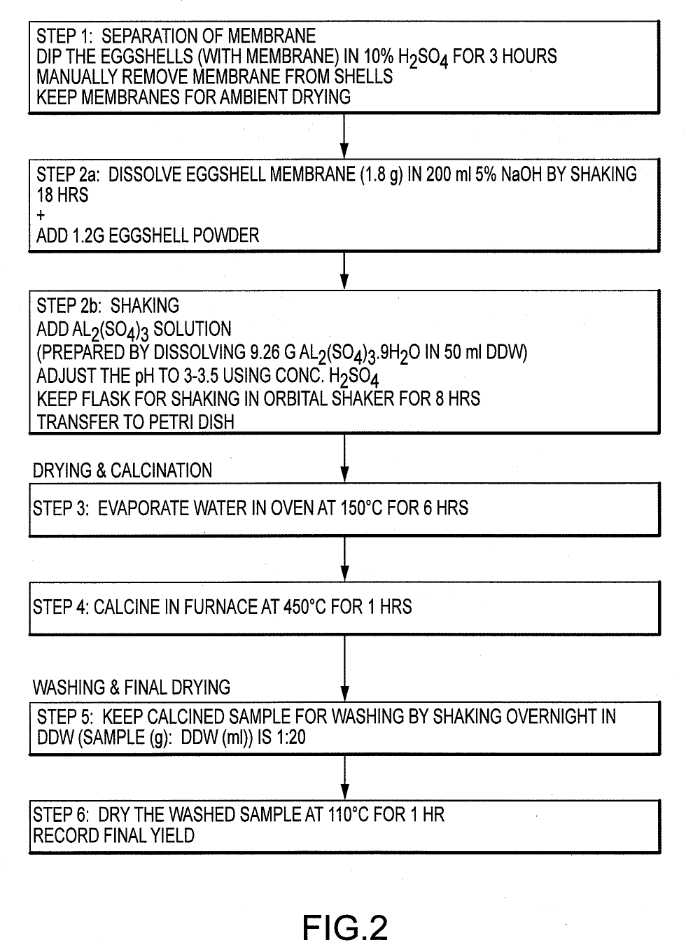

After calcining (134), the calcined mass (135) may be washed (136) to produce a washed mass (137). The washing may remove unreacted calcium and aluminum ions. After washing, the washed mass may be again dried (e.g., at 90-130° C.), thereby producing the final ESM adsorbent product. A particular process for producing ESM adsorbents is illustrated in FIG. 2.

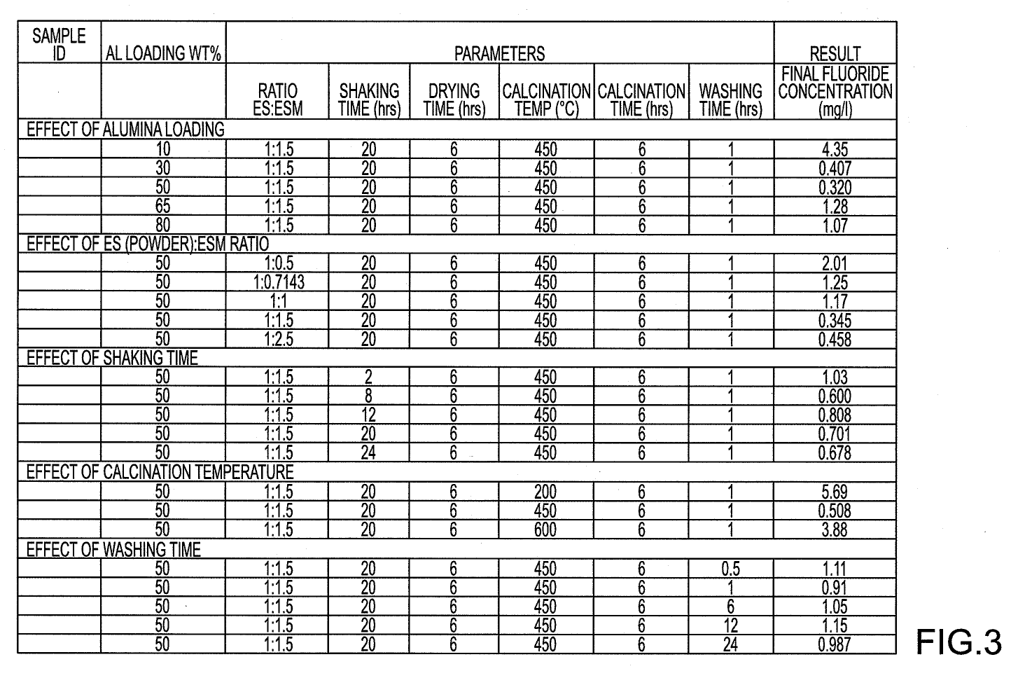

As is described in further detail below, the ESM absorbent is capable of removing fluoride from water. The removal efficiency of the ESM absorbent may be sensitive to the process conditions utilized to produce the ESM adsorbent. FIG. 3 illustrates the effect of varying production parameters and the ability of the produced ESM adsorbent to remove fluoride from water. As illustrated in FIGS. 1b and 3, with respect to the step of combining ESM with aluminum and/or calcium (120), the alumina loading (based on the wt. % of the Al₂(SO4)₃ in solution) may be in the range of from 10-80 wt. %. In one embodiment, the alumina loading is at least about 10 wt. %, such as at least about 20 wt. %, or at least about 30 wt. %. In one embodiment, the alumina loading is not greater than about 80 wt %, such as not greater than about 65 wt. %. In one embodiment, the alumina loading is in the range of from about 20 wt. % to about 65 wt. %. In one embodiment, the alumina loading is in the range of from about 45 wt. % to about 55 wt. %. In one embodiment, the alumina loading is about 50 wt. %.

With respect to the step of combining ESM with aluminum and/or calcium (120), when the calcium source is eggshell powder, the ratio of ESM to eggshell powder (ES) in solution may be in the range of from about 1:0.5 (ES:ESM) to 1:2.5 (ES:ESM). In one embodiment, the ratio of ES:ESM is at least about 1:0.5, such as at least about 1:0.7 or even at least about 1:1. In one embodiment, the ratio of ES:ESM is not greater than about 1:2.5, such as not greater than about 1:2. In one embodiment, the ratio of ES:ESM is in the range of 1:1 to 1:2, such as from about 1:1:25 to about 1:1.75. In one embodiment, the ratio of ES:ESM is about 1:1.5.

With respect to the combining step (120), the solution comprising the ESM and other materials may be agitated (129) for various amounts of time. In one embodiment, the solution is agitated (e.g., shaken or stirred, to name a few) for at least about 2 hours, but not greater than 24 hours. In some embodiments, the agitation time is at least about 4 hours, or at least about 6 hours. In some embodiments, the agitation time is not greater than 20 hours, or not greater than about 12 hours. In one embodiment, the agitation time is in the range of 2-10 hours. In one embodiment, the agitation time is in the range of 5-9 hours. In one embodiment, the agitation time is about 8 hours. Of course, the agitation time may be dependent on the volume of solution relative to the surface area of the vessel and/or the agitation capability of the agitator.

With respect to the recovering ESM adsorbent step (130), the calcining temperature (134) may be at least 200° C., but not greater than 650° C. In one embodiment, the calcining temperature is from about 400° C. to about 500° C. In one embodiment, the calcining temperature is about 450° C.

With respect to the recovering ESM adsorbent step (130), the washing time (136) may be in the range of 0.5 hour to about 25 hours. In some embodiments, the washing time is not greater than about 12 hours, or not greater than about 6 hours. In one embodiment, the washing time is in the range of from about 0.5 hours to about 4 hours. In one embodiment, the washing time is about 1 hour.

ESM adsorbents produced via these methodologies are generally of a composite nature and comprise from about 45 or 50 wt. % alumina to about 60 or 65 wt. % alumina, from about 10 or 12 wt. % calcium oxide to about 20 or 22 wt. % calcium oxide, 1-5 wt. % carbon, and about 5-15 wt. % sulfur. The carbon may be in the form of, for example, carbonates. The sulfur may be in the form of, for example, sulfates. The ESM adsorbents may include up to 5 wt. % incidental elements and impurities (e.g., nitrogen and hydrogen, to name a few). In one embodiment, an ESM adsorbent comprises 50-60 wt. % alumina, 12-20 wt. % calcium oxide, 2-4 wt. % carbon, and 7-15 wt. % sulfur.

The ESM adsorbent may realize improved adsorption capacity and selectivity. This may be due to one or more of, for example, (i) an interwoven structure that facilitates formation of hierarchical nanocrystallites of alumina and calcium based compounds; (ii) alumina and calcite phase supported on N-enriched nonporous and macroporous carbon may impart selectivity and stabilization to alumina and calcite phases; (iii) a plurality of crystalline phases of alumina, as well as calcite based compounds; (iv) transitional alumina formation as an intermediate to fully developed alpha crystalline alumina may be responsible for enhanced adsorption; (v) enhanced adsorption may be realized due to surface acidity; (vi) supporting alumina on carbon may lead to the formation of both highly acidic Lewis and Brönsted acid sites (BAS's), the former through isomorphous substitution of carbon ions by Al³⁺ ions at tetrahedral lattice sites, and the latter through formation of bridged hydroxy groups, similar to those found in zeolites; (vii) a nanocrystalline mixed phase of alumina and calcite may realize a synergistic effect; and/or (viii) use of a low specific surface area of (approx. 20 m²/g) indicates that the bio-ceramic adsorbent is nonporous or macroporous in nature.

Activated alumina is widely used for defluoridation of water. The fluoride removing efficiency of activated alumina is adversely affected by hardness, pH, presence of other ions and surface loading (the ratio of total fluoride concentration to activated alumina dose). The adsorbent process for activated alumina is pH specific, and maximum removal of fluoride generally occurs between a pH of 4.5 to 5. At a pH higher than 7, silicate and hydroxide ions become stronger competitors for fluoride ions, while at a pH less than 4, activated alumina may dissolve, leading to loss of adsorbing media with release of Al ions. Presence of sulfate, phosphate or carbonate results in ionic competition with fluoride ion, and hence adsorption capacity for activated alumina is usually low in the presence of such anions.

Conversely, the ESM adsorbent of the present disclosure may realize a high adsorption capacity over a wide range of pH and/or high anion concentrations. In some embodiments, the ESM adsorbent has a better fluoride adsorption capacity than activated alumina. In one embodiment, the ESM adsorbent has a fluoride adsorption capacity of at least about 5 mg/g, or at least about 8 mg/g, or at least about 10 mg/g, or at least about 15 mg/g, or at least about 20 mg/g. In one embodiment, the water comprises a fluoride concentration of not greater than 100 mg/liter. In one embodiment, the water comprises a fluoride concentration of about 50-60 ppm. In one embodiment, the ESM adsorbent is able to achieve the above-noted fluoride removal capacity rates in the pH range of 4 and 9. In one embodiment, the bio-ceramic adsorbent is in insensitive to pH shifts in the pH range of 5 to 8, or is in insensitive to pH shifts in the pH range of 4 to 9, or even is in insensitive to pH shifts in the pH range of 3 to 11.

In one embodiment, the ESM adsorbent is more selective than activated alumina. In one embodiment, the ESM adsorbent is able to achieve the above-noted fluoride removal capacity rates even in the presence of sulfate anions, such as sulfate levels of at least about 500 mg/L, or at least about 1000 mg/L, or at least about 2000 mg/L, or at least about 5000 mg/L, or even at least about 10,000 mg/L. In one embodiment, the ESM adsorbent is able to achieve the above-noted fluoride removal capacity rates even in the presence of other anions, such as one or more of chloride, carbonate, or bicarbonate anions, to name a few.

Chitin Based Adsorbents

The bio-ceramic adsorbent may also/alternatively comprise chitin and the like, such as in addition to or as a replacement for ESM. In one embodiment, the chitin is utilized in the bio-ceramic adsorbent instead of ESM. Since chitin and ESM share similar characteristics, the methodologies and adsorbent characteristics provided above with respect to the ESM may be replicated or exceeded via chitin and the like. Such chitin based adsorbents are sometimes referred to herein as CBA.

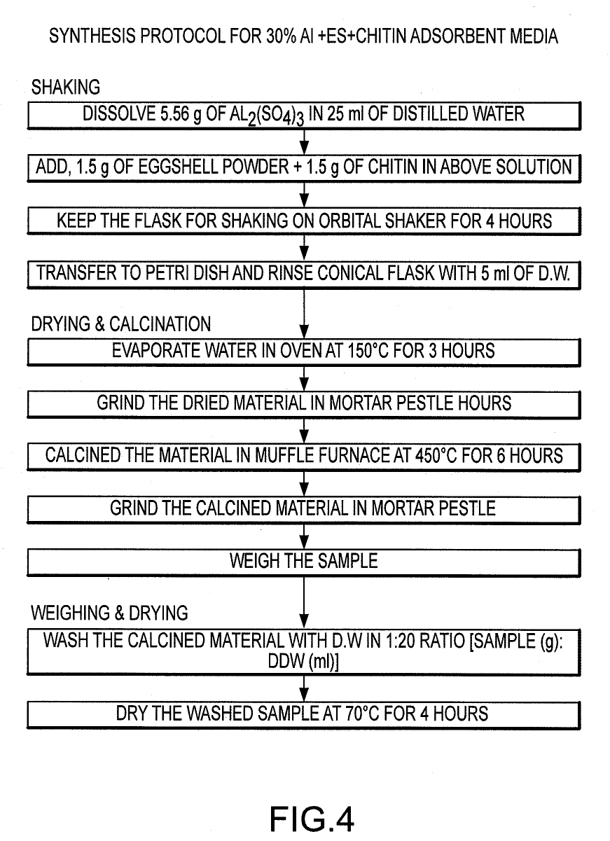

The methodologies described above to produce ESM adsorbents may be utilized to prepare chitin based adsorbents, such as, for example, any of the methodologies described in FIGS. 1a-1c, by substituting chitin for ESM. One particular method for preparing a chitin based adsorbent (CBA) is illustrated in FIG. 4.

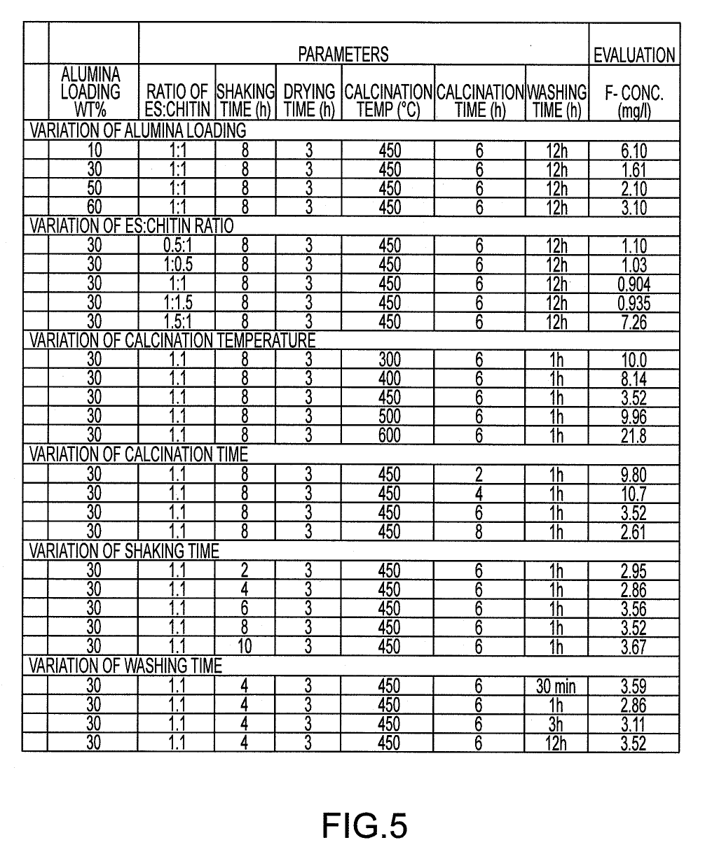

As is described in further detail below, the CBA may be capable of removing fluoride from water. The removal efficiency of the CBA may be sensitive to the process conditions utilized to produce the CBA adsorbent. FIG. 5 illustrates the effect of fluoride adsorption relative to varying CBA production parameters.

For the CBA, alumina loading is generally in the range of 10-60 wt. % (based on the wt. % of the Al₂(SO4)₃ in solution). In one embodiment, the alumina loading is in the range of from about 25 wt. % to about 35 wt. %. In one embodiment, the alumina loading is about 30 wt. %.

When eggshell is the calcium source, the weight ratio of eggshell to chitin (ES:C) may be in the range of 0.5:1-1.5:1. In one embodiment, the weight ratio of eggshell to chitin is 1:1.

The agitation time may be in the range of 2-10 hours. In one embodiment, the agitation time is in the range of 3-5 hours. In one embodiment, the agitation time is about 4 hours.

The drying time may be in the range of 2-4 hours. In one embodiment, the drying time is about 3 hours.

The calcining temperature may be in the range of 300-600° C. In one embodiment, the calcining temperature is in the range of 400-500° C. In one embodiment, the calcining temperature is about 450° C.

The calcining time may be in the range of 2-8 hours. In one embodiment, the calcining time is in the range of 5-7 hours. In one embodiment, the calcining time is about 6 hours.

The washing time may be in the range of 0.5-12 hours. In one embodiment, the washing time is in the range of 0.5-3 hours. In one embodiment the washing time is in the range of 1-2 hours.

The CBA is generally in the form of a powder and generally comprises 15 or 20 wt. % alumina to about 30 or 35 wt. % alumina, from about 20 or 25 wt. % calcium oxide to about 35 or 40 wt. % calcium oxide, 1-5 wt. % carbon, and from about 5 or 10 wt. % sulfur to about 15 or 20 wt. % sulfur. The carbon may be in the form of, for example, carbonates. The sulfur may be in the form of, for example, sulfates. The CBA may include up to 5 wt. % incidental elements and impurities (e.g., nitrogen and hydrogen, to name a few). In one embodiment, a CBA adsorbent comprises 15-25 wt. % alumina, 25-35 wt. % calcium oxide, 2-4 wt. % carbon, and 8-18 wt. % sulfur.

The CBA and/or ESM may be agglomerated via conventional methods to produce a granulated media.

As illustrated via the below examples, the CBA generally performs better with respect to fluoride removal than both activated alumina and ESM-based adsorbents.

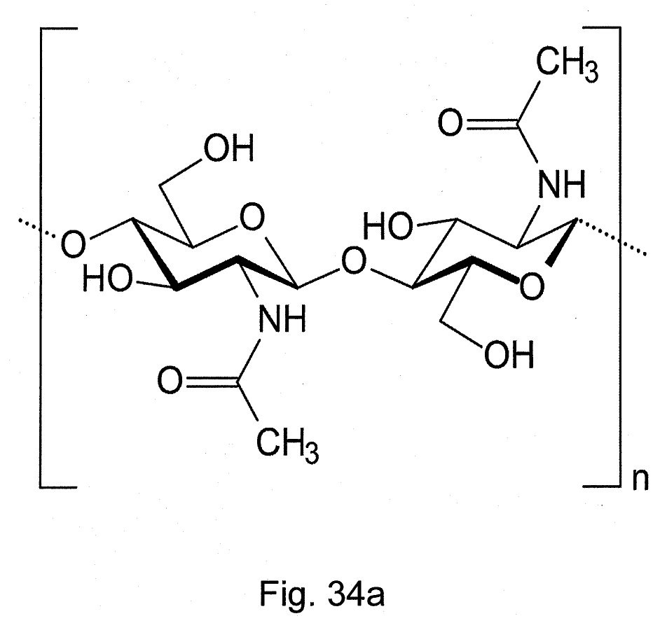

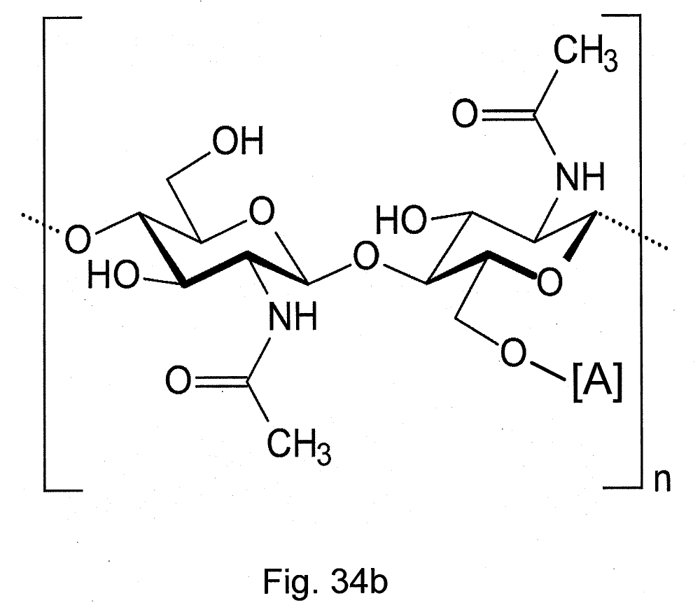

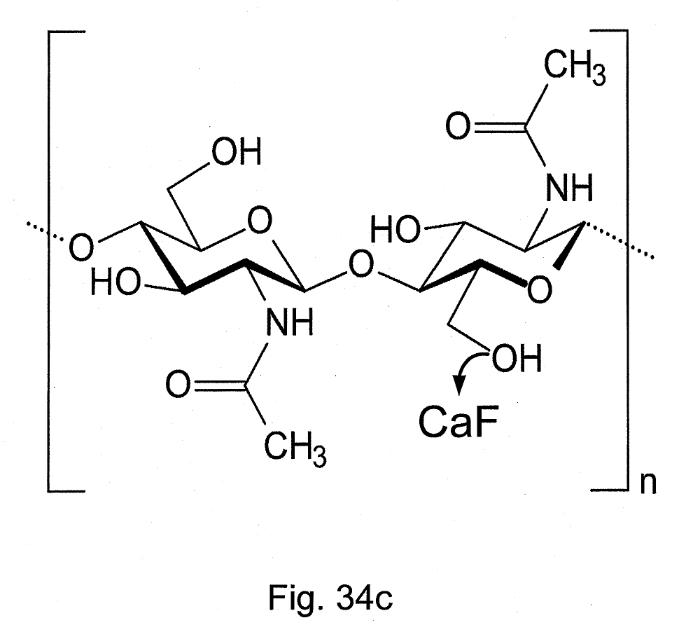

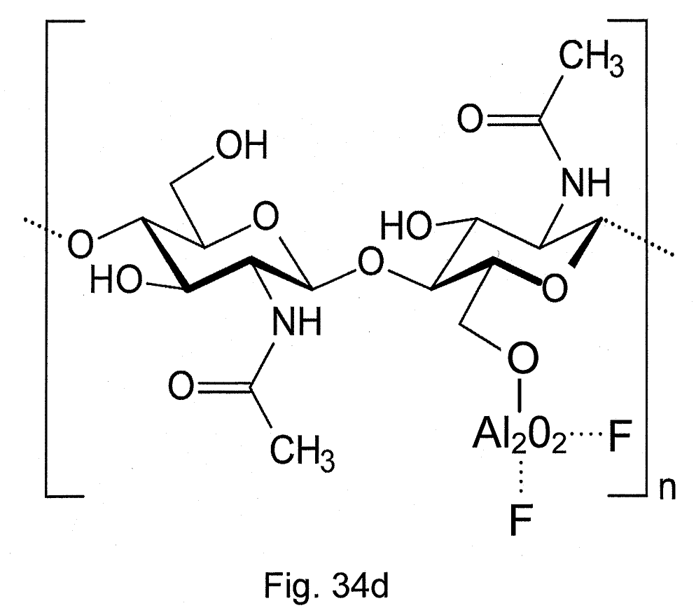

It is theorized (and there is no intent to be bound herein by theory) that bio-ceramic adsorbents comprising chitin may be formed via substitution of one or more hydroxyl groups or amide groups bound to the chitin. Referring now to FIGS. 34a-34d, embodiments relating to these theorized bio-ceramic adsorbents are illustrated. FIG. 34a illustrates the chemical structure of one unit of chitin. FIG. 34b illustrates one theoretical embodiment of a bio-ceramic adsorbent comprising chitin. In this embodiment, the lower hydroxyl group (OH) has been replaced (substituted) with a metal oxide group [A]. In the illustrated embodiment only a single hydroxyl group is substituted, but it is appreciated that the metal oxide group may be also/alternatively bound to the other hydroxyl groups and/or the amide groups (CH₃—C═O—NH) of the chitin.

This metal oxide group [A] may be any suitable metal oxide, but is generally is one of an aluminum or calcium salt. In one embodiment, the metal oxide is a calcium salt. In this embodiment, and with reference now to FIG. 34c, in the presence of fluoride in water, calcium may precipitate as CaF, thereby removing fluoride from water. In another embodiment, the metal oxide is an aluminum salt. In one embodiment, and with reference now to FIG. 34d, the aluminum salt may be alumina, which may attract fluoride, as illustrated.

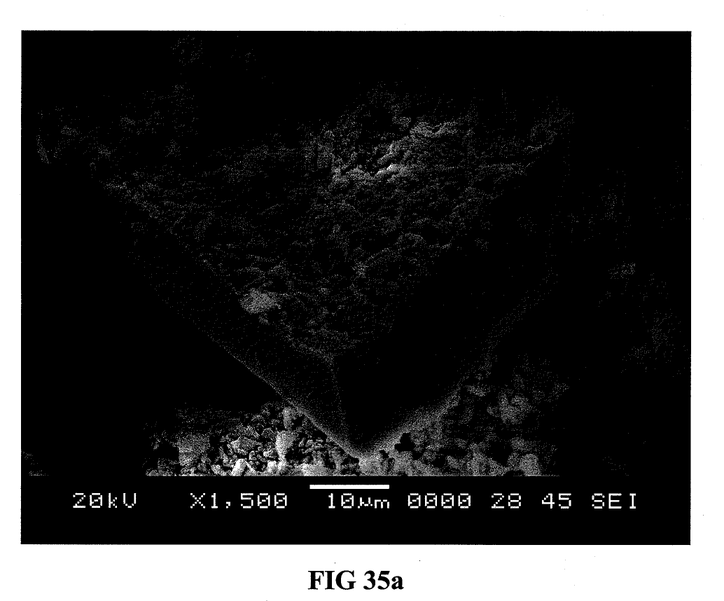

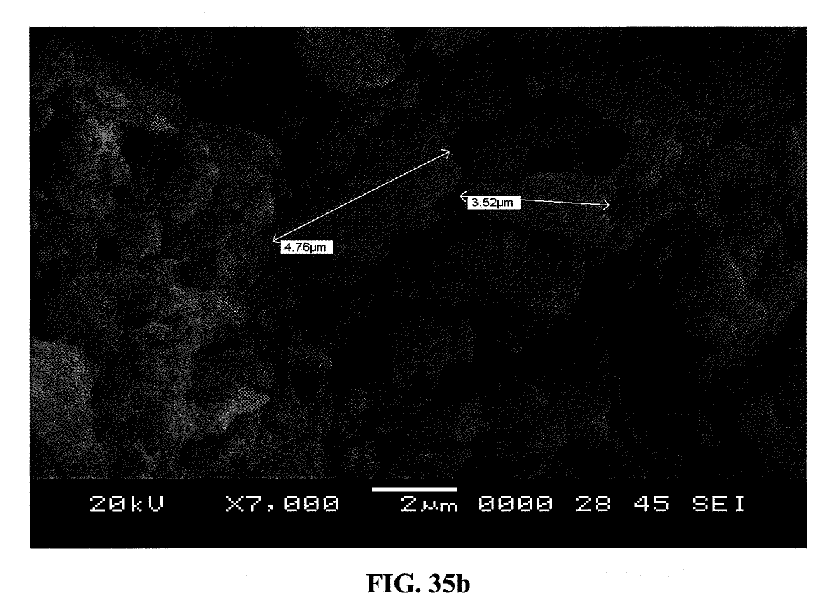

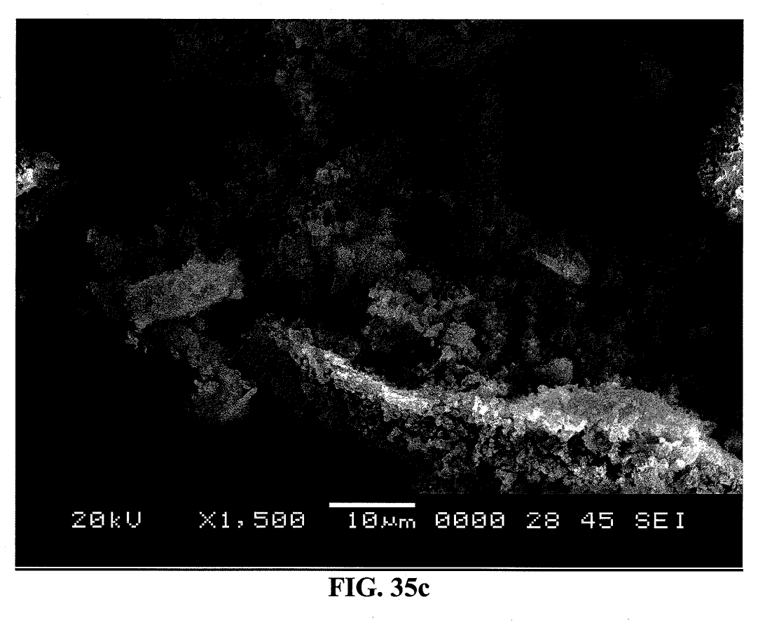

SEMs illustrating chitin and eggshell embodiments of the bio-ceramic adsorbent are illustrated in FIGS. 35a-35c. FIG. 35a is an SEM illustrating a chitin bio-ceramic adsorbent comprising aluminum salt. FIG. 35b illustrates irregularly shaped aluminum particles with agglomerates of small particles adhered on the surface of eggshell—flat needle like structure are observed. FIG. 35c illustrates the structure after contacting the adsorbent with a fluoride-containing water.

### EXAMPLES

### Example 1

### ESM-A-1

An ESM adsorbent is produced similar to the methodology provided for by FIG. 2. In this example, the aluminum loading is about 50%, the ratio of ES:ESM is about 1:1.5, the agitation time is about 8 hours, the calcining temperature is about 450° C., and the washing time is not greater than about 1 hour. This ESM adsorbent is described in further detail below as “ESM-A-1”.

ESM-A-1 is analyzed via a ICP-AES technique, and CHN analysis. A Perkin Elmer ICP-OES 4100 BV instrument is used for the analysis of acid digested samples, and the CHN analysis is carried out using a Vario Elementar instrument. Table 5 provides the chemical analysis results for the ESM-A-1:

TABLE 5
Chemical analysis results for ESM-A-1

| Material | Al₂O₃ wt. % | CaO wt % | C wt % | S wt % | Impurities |
|---|---|---|---|---|---|
| ESM-A-1 | 55.59 | 16.75 | 2.38 | 8.36 | <5% |

The chemical composition of the ESM-A-1 material suggests that the material is a composite having a plurality of phases, with alumina and calcium based phases being the major components. The presence of carbon is likely via incorporation into the alumina phase. The carbon may be in the form of carbonates. The sulfur may in the form of sulfates.

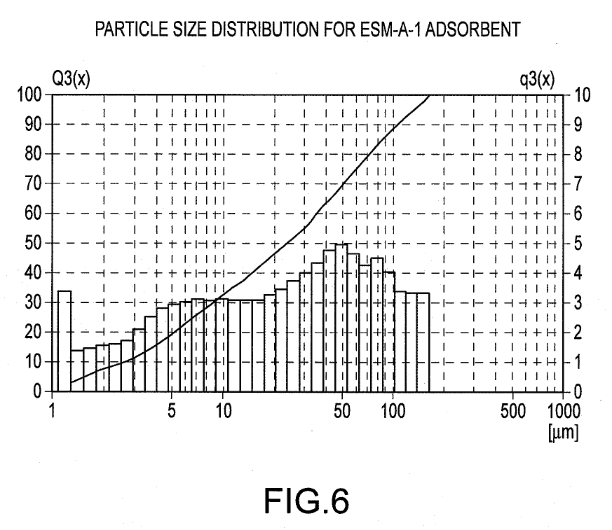

The specific surface area of various ESM-A-1 samples is determined using a specific surface area analyzer (ASAP 2000, Micromeritics) with nitrogen gas as the adsorbate. The particle size of various ESM-A-1 samples is determined on Fritsch particle sizer. The ESM-A-1 material realizes a specific surface area of about 20 m²/g and average particle size d₅₀ of about 23 micron and d₉₀ of 100 micron, depending on synthesis and homogenization method used. The particle size distribution curve is shown in FIG. 6.

ESM-A-1 is also evaluated using microscopy. SEM photos are obtained. These photos suggest the presence of both coarse and fine particles with irregular shaped surface morphology and a porous surface. The SEM photos indicate fine particles with a size range of 10-20 micron and coarse particles in the range of 30-60 microns. Some needle shaped particles in the size range of 70-100 microns are also present.

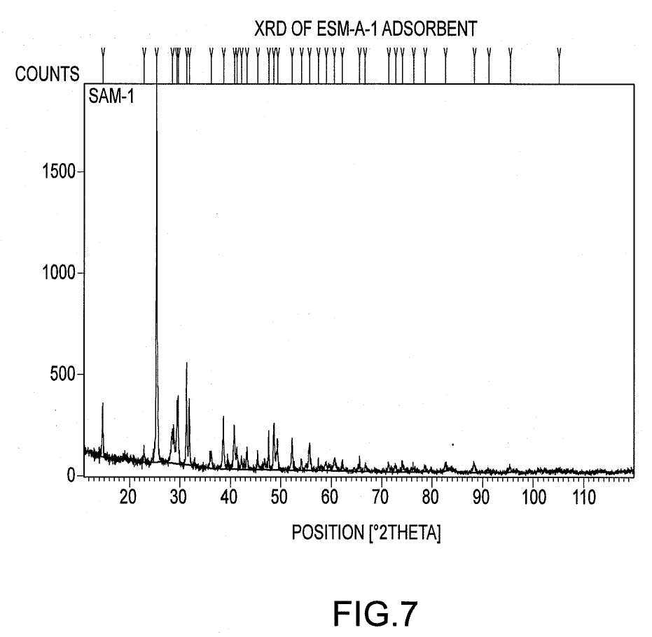

The structural details and phase identification of ESM-A-1 is carried out by an x-ray diffraction analysis. Powder X-ray diffraction studies are carried on Phillips analytical diffractometer with monochromated CuKα radiation (λ−1.54 Å). The scanning range of 2θ is set between 3° and 60°. The XRD pattern and data is given FIG. 7.

The XRD analysis shows the presence of multiple phases, with prominent presence of crystalline alumina as well as amorphous alumina phases. The crystalline alumina phases correspond to rhombohedral, as well as orthorhombic symmetries. However, considerable amounts of crystalline calcium sulfate, calcium carbonate and other phases are present. The XRD analysis suggests that the ESM-A-1 adsorbent is a composite material with complex mixture of amorphous and crystalline phases, dominated by alumina and calcium based compounds.

I. Batch Adsorption Studies

Batch adsorption experiments are conducted for screening of the bio-ceramic adsorbent, and to investigate the effect of various parameters, such as amount of adsorbent, initial concentration, contact time, presence of interfering ions and pH. All chemicals used in the batch adsorption studies are of analytical reagent grade. A simulated wastewater stock solution of fluoride is prepared by dissolving an adequate amount of sodium fluoride, sodium sulfate, sodium chloride and sodium carbonate (F/SO4/Cl/CO3:15/300/100/200 mg/L) in distilled water. 100 ml of the simulated fluoride solution is taken in a PVC conical flask, and a known weight of adsorbent material is added and kept on a rotary shaker for 24 hours. The solution is filtered, and the filtrate is analyzed for residual fluoride concentration by ion selective electrode method using an Orion Ion electrode instrument. Fluoride estimation is also carried out using ion chromatography (Model: IES 300) to verify results. The release of any undesired elements from adsorbent after the equilibrium adsorption study is estimated by ICP-AES method. The experimental error is observed to be within ±2%. All adsorption experiments are conducted at room temperature of 30±2° C.

The preliminary adsorption experiments are carried out using various adsorbents including bentonite, 10% La-bentonite, activated alumina, La-VGL-alumina, Plaster of Paris, cement, 10% La-chitosan beads, meso alumina, alumina incorporated on meso-alumina, titania incorporated on meso-alumina and ESM-A-1. The adsorption capacities of these adsorbents are shown in Table 6. The ESM-A-1 based adsorbent realizes the highest adsorption capacity of all adsorbents.

TABLE 6
Freundlich and Langmuir adsorption constants for different adsorbents
in simulated wastewater

| | Freundlich model | | | Langmuir Model | | |
|---|---|---|---|---|---|---|
| | K_{F} | | | qₘₐₓ | K | |
| Adsorbents | (mg/g) | 1/n | R² | (mg/g) | (l/mg) | R² |
| La-Bentonite | 1.34 | 0.1731 | 0.988 | 2.92 | 2.82 | 0.977 |
| Activated alumina | 0.087 | 2.306 | 0.996 | | | |
| La-V-GL-alumina | 0.241 | 1.742 | 0.946 | | | |
| Cement | 0.725 | 0.621 | 0.925 | 4.54 | 0.0776 | 0.928 |
| POP | 0.287 | 0.946 | 0.995 | | | |
| ESM | 1.48 | 0.42 | 0.94 | 6.41 | 0.67 | 0.98 |
| ESM-A-1 | 2.46 | 0.31 | 0.94 | 16.31 | 0.95 | 0.99 |
| adsorbent | | | | | | |
| 10% La-Chitosan | 1.47 | 0.152 | 0.95 | 3.11 | 4.32 | 0.95 |
| beads | | | | | | |
| 50% Al-Meso | 0.22 | 1.78 | 0.99 | | | |
| alumina | | | | | | |
| 20% Ti-Meso | 0.79 | 0.11 | 0.91 | 0.86 | 0.66 | 0.98 |
| alumina | | | | | | |
| Meso alumina | 0.37 | 0.60 | 0.86 | | | |

Conditions:
Initial fluoride conc. = 15 mg/L;
Contact time = 24 hrs;
alt combinations: SO₄/Cl/CO₃: 300/100/200 mg/L;
Temperature = 30 ± 2° C.

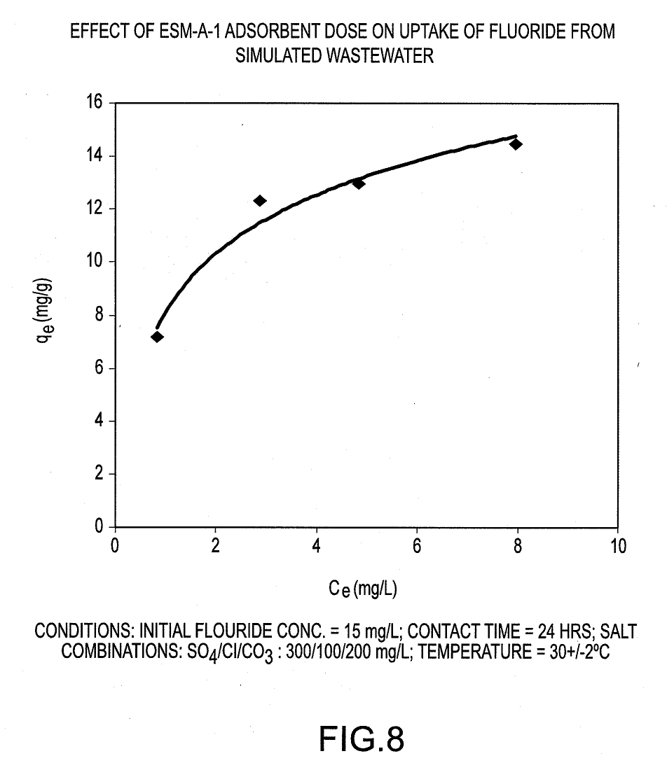

The effect of ESM-A-1 adsorbent dose on uptake of fluoride from simulated wastewater is illustrated in FIG. 8. As illustrated, the adsorption capacity of the ESM-A-1 adsorbent increases with increase in adsorbent dose, and thereafter reaches equilibrium. The ESM-A-1 adsorbent realizes an equilibrium concentration of fluoride less than 5 mg/L at an adsorbent dose of 0.8 g/L.

The distribution of fluoride between the liquid phase and the solid phase is a measure of the position of equilibrium in the adsorption process and can be expressed by the Freundlich and Langmuir equations. These two models are widely used, the former being purely empirical and the latter assumes that maximum adsorption occurs when the surface is covered by the adsorbate. The Freundlich model, which is an indicative of surface heterogeneity of the sorbent, is given by the following linearized equation:

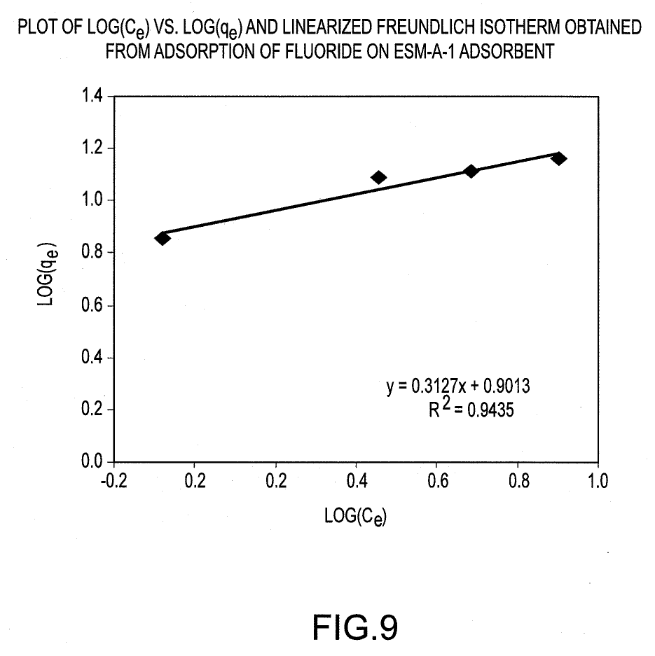

log(qₑ)=log K_{F}+1/n log(Cₑ) (1)

where K_{F} and 1/n are Freundlich constants related to adsorption capacity (mg/g) and adsorption intensity, respectively. For the ESM-A-1 adsorbent, as illustrated in FIG. 9, the value of K_{F} is approximately 2.5 mg g⁻¹ and 1/n is 0.31 for Freundlich isotherm with a regression coefficient of 0.94.

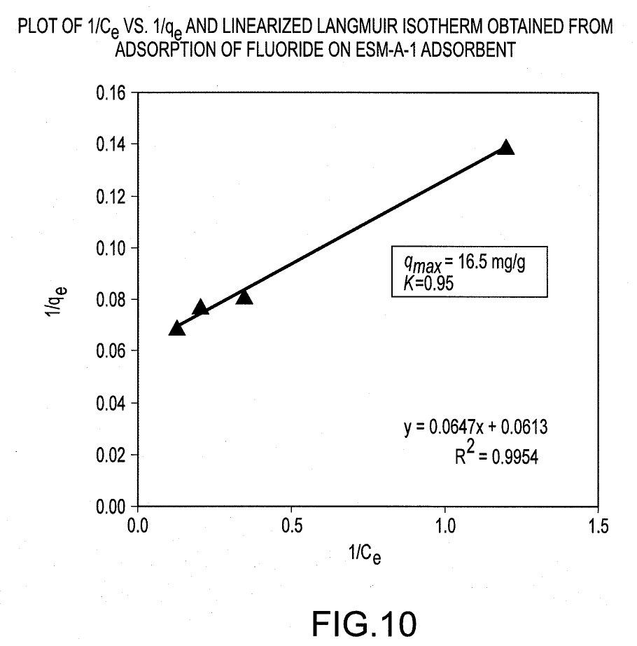

The Langmuir equation, which is valid for monolayer sorption onto a surface with a finite number of identical sites, is given by:

$$\frac{1}{{q}_{e}} = \frac{1}{{q}_{max} K} \times \frac{1}{{C}_{e}} + \frac{1}{{q}_{max}} \qquad ( 2 )$$

where qₘₐₓ is the maximum amount of the fluoride ion per unit weight of adsorbent (mg/g), and K is a equilibrium adsorption constant related to the affinity of solute towards the binding sites (L/mg). For the ESM-A-1 adsorbent, the linear plot of 1/Ce versus 1/qe, as illustrated in FIG. 10, indicates the applicability of Langmuir adsorption isotherm. The values of Langmuir parameters, qₘₐₓ and K are approximately 16.5 mg/g and 0.95 L mg⁻¹, respectively with regression coefficient of 0.995. The equilibrium adsorption data fit well both for Langmuir and Freundlich adsorption isotherm models for the ESM-A-1 adsorbent.

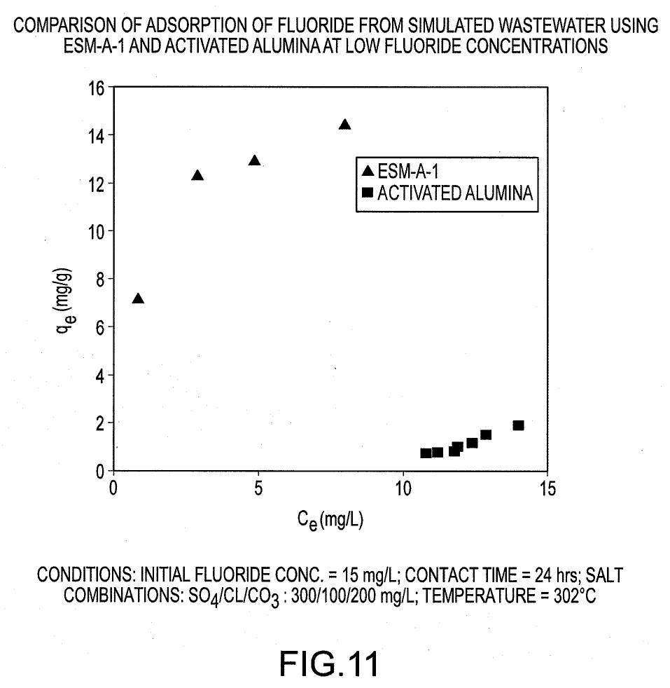

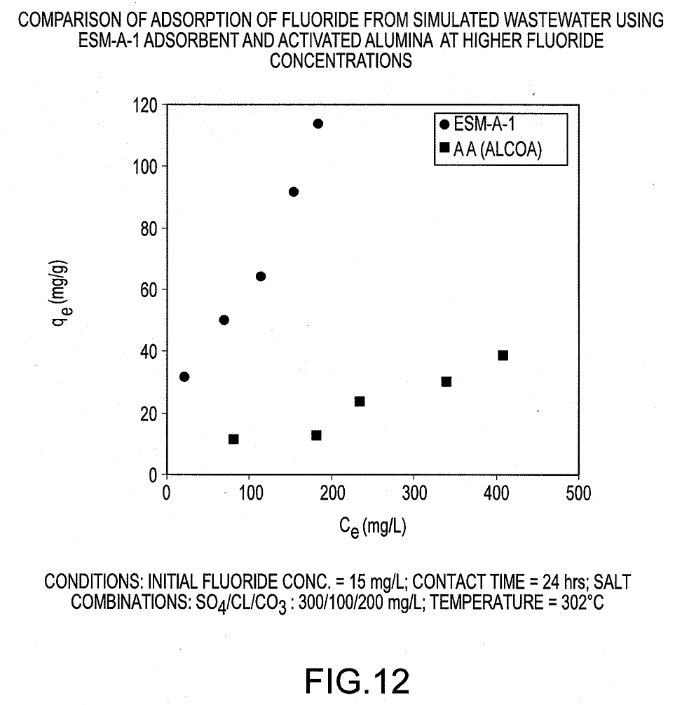

The defluoridation of activated alumina is compared with the ESM-A-1 adsorbents at a fluoride concentration of 15 mg/L. The uptake of fluoride from simulated wastewater for the ESM-A-1 adsorbent and activated alumina is illustrated in FIGS. 11 and 12. The ESM-A-1 adsorbent realizes higher adsorption capacity as compared to activated alumina. These results indicate that the ESM-A-1 adsorbent is a more effective adsorbent than activated alumina for defluoridation of water containing competing ions.

The Freundlich and Langmuir adsorption constants for the ESM-A-1 adsorbent and activated alumina at lower and higher concentrations of fluoride are given in Tables 7 and 8. The ESM-A-1 realizes a higher adsorption capacity with higher initial concentration of fluoride than activated alumina.

TABLE 7
Freundlich and Langmuir Adsorption Constants for ESM-A-1
adsorbent and activated alumina at lower conc. in simulated
wastewater

| | Freundlich model | | | Langmuir Model | | |
|---|---|---|---|---|---|---|
| | K_{F} | | | qₘₐₓ | K | |
| Adsorbents | (mg/g) | 1/n | R² | (mg/g) | (l/mg) | R² |
| ESM-A-1 adsorbent | 2.46 | 0.313 | 0.94 | 16.31 | 0.95 | 0.99 |
| Activated alumina | 0.0135 | 4 | 0.95 | 0.23 | 18.46 | 0.98 |

Conditions:
Initial fluoride conc. = 15 mg/L;
Contact time = 24 hrs;
Salt combinations: SO₄/Cl/CO₃: 300/100/200 mg/L;
Temperature = 30 ± 2° C.

TABLE 8
Freundlich and Langmuir Adsorption Constants for ESM-A-1
adsorbent and activated alumina at higher conc. in simulated
wastewater

| | Freundlich model | | | Langmuir Model | | |
|---|---|---|---|---|---|---|
| | K_{F} | | | qₘₐₓ | K | |
| Adsorbents | (mg/g) | 1/n | R² | (mg/g) | (l/mg) | R² |
| ESM-A-1 adsorbent | 1.13 | 0.84 | 0.95 | 322 | 0.0025 | 0.94 |
| Activated alumina | 0.715 | 0.725 | 0.99 | 70 | 0.0024 | 0.99 |

Conditions:
Initial fluoride conc. = 15 mg/L;
Contact time = 24 hrs;
Salt combinations: SO₄/Cl/CO₃: 300/100/200 mg/L;
Temperature = 30 ± 2° C.

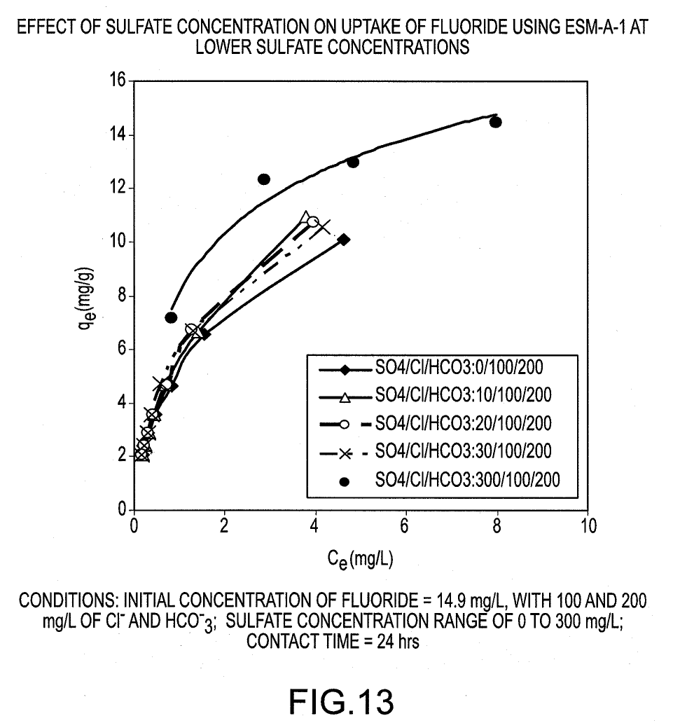

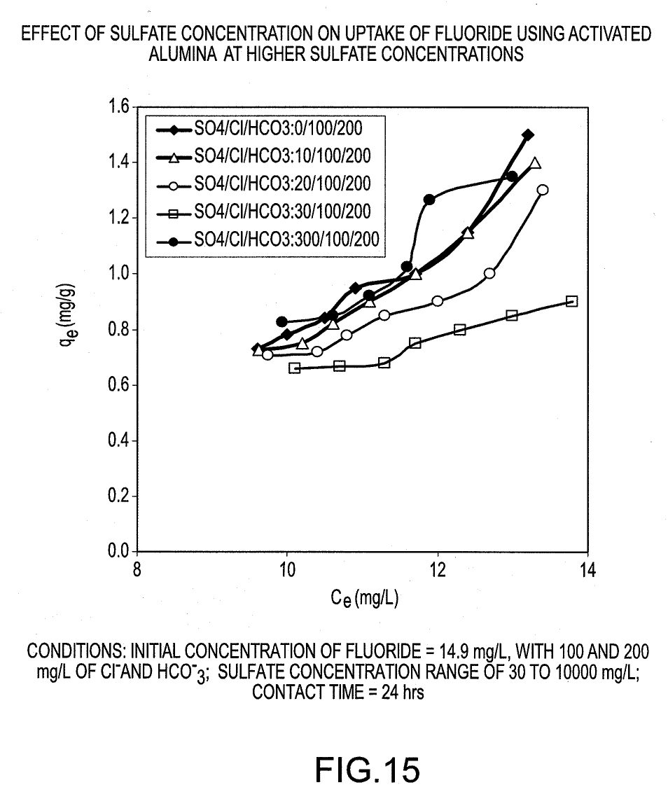

Industrial wastewater often contains a high concentration of other anions and cations making fluoride removal more difficult. For example, sulfate may interfere with fluoride removal in smelting wastewaters. The effect of sulfate concentrations on uptake of fluoride from simulated wastewater using the ESM-A-1 adsorbent and activated alumina is studied, and the results are illustrated in FIGS. 13-15.

As illustrated, the uptake of fluoride increases in the ESM-A-1 adsorbent with increase in sulfate concentration. The ESM-A-1 adsorbent is less sensitive to sulfate concentration conditions than activated alumina.

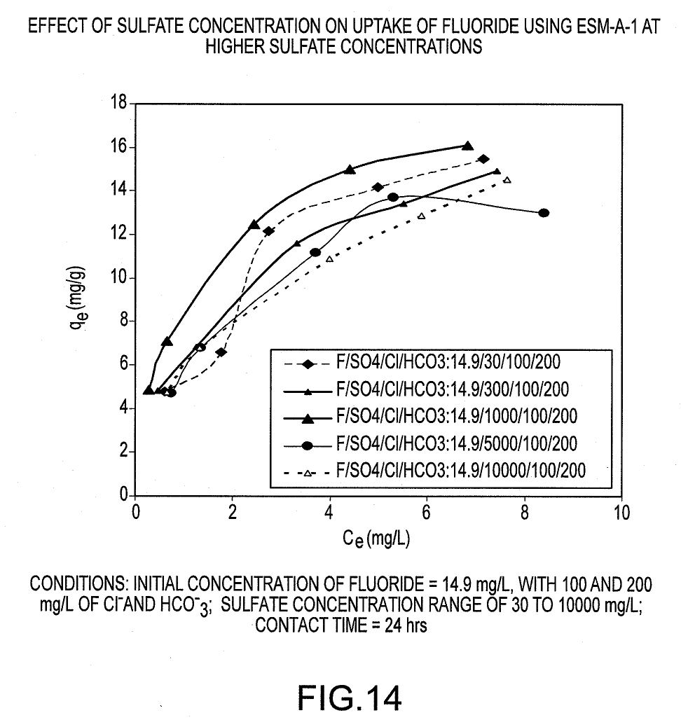

The effect of sulfate concentration on uptake of fluoride on ESM-A-1 adsorbent is studied in the range of 0 mg/L to 10 g/L (e.g., similar to the range of sulfate anions in wastewater). As illustrated in FIG. 14, the uptake of fluoride increases with increase in sulfate concentration up to sulfate concentration of 1000 mg/L. It is expected that similar results would be realized in the presence of chloride ions.

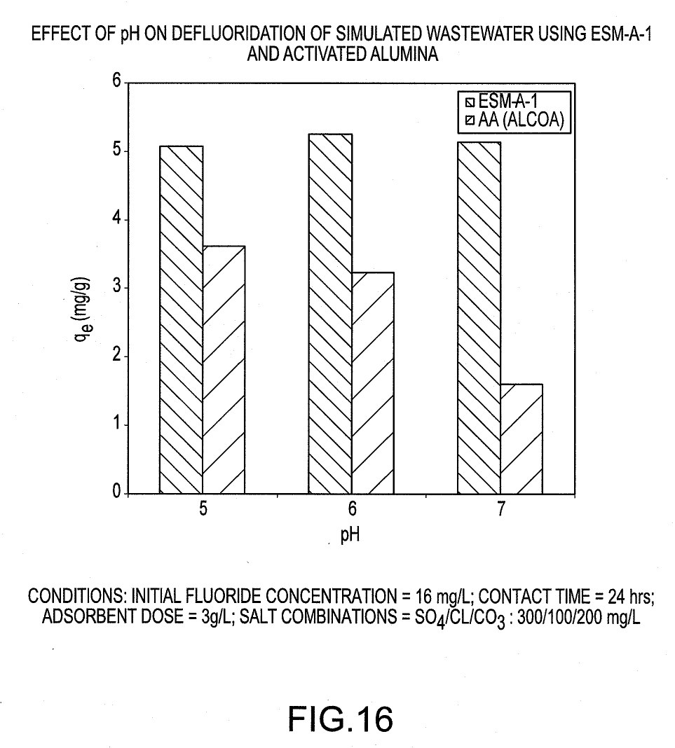

Defluoridation of water via adsorption may be dependent on pH. The influence of pH on the uptake of fluoride is studied at different pHs, namely a pH of 5, 6 and 7 using ESM-A-1 adsorbent and activated alumina. The results are illustrated in FIG. 16. As illustrated, pH has negligible effect on uptake of fluoride using the ESM-A-1 adsorbent. However, pH has a pronounced effect on uptake of fluoride using activated alumina.

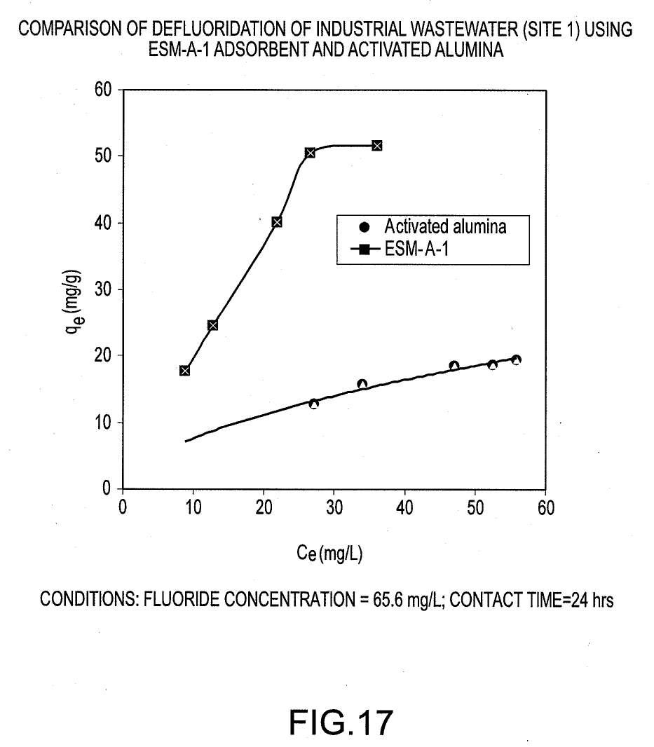

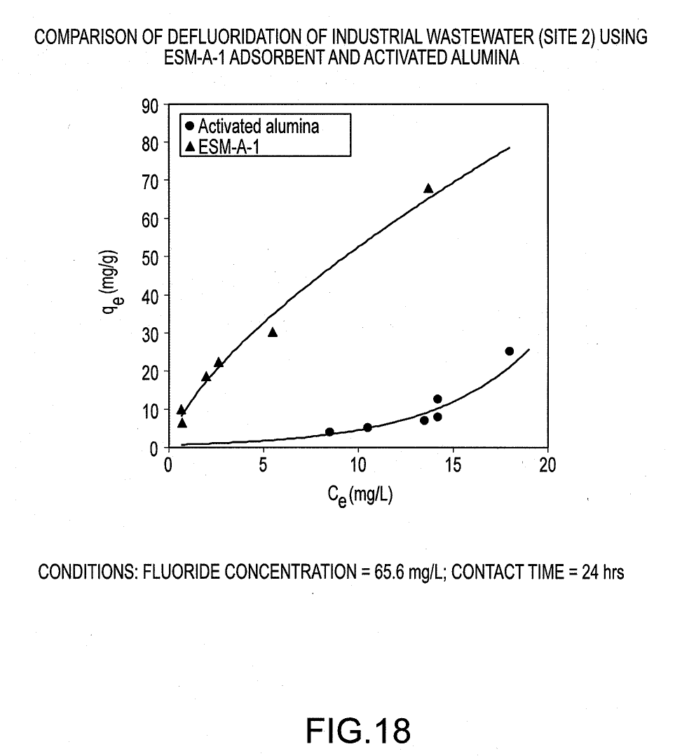

The uptake of fluoride from actual industrial wastewater using ESM-A-1 adsorbent and activated alumina is studied. Fluoride-containing waters from two industrial sites, SITE 1 and SITE 2 are obtained. The adsorption results of the ESM-A-1 and activated alumina media for these sites are illustrated in FIGS. 17 and 18. The values of adsorption capacity and equilibrium constants for the ESM-A-l adsorbent and activated alumina in SITE 1 and SITE 2 wastewaters are provided in Table 9, below. The adsorption capacity of the ESM-A-1 adsorbent is about 5.5 times higher than that of activated alumina for SITE 1 wastewater.

TABLE 9
Langmuir adsorption constants for ESM-A-1 adsorbent and
activated alumina in SITE 1 and SITE 2 wastewaters

| | ESM-A-1 adsorbent | | | Activated alumina | | |
|---|---|---|---|---|---|---|
| | qₘₐₓ | K | | qₘₐₓ | K | |
| Type of wastewaters | (mg/g) | (L/mg) | R² | (mg/g) | (L/mg) | R² |
| SITE 1 wastewater | 208.33 | 0.011 | 0.99 | 38.02 | 0.019 | 0.97 |
| SITE 2 wastewater | 116.28 | 0.087 | 0.99 | — | — | — |

ii. Kinetic Studies

In order to estimate equilibrium adsorption time for the uptake of fluoride by the ESM-A-1 adsorbent and activated alumina, time dependent sorption studies are conducted in a PVC vessel having a capacity of 500 ml. A fluoride-containing water is transferred into the vessel, and a known weight of adsorbent, corresponding to doses of 1 g/l, 3 g/l and 5 g/l, is added to the vessel. The suspension is stirred using a four-blade, pitched turbine impeller with a stirring speed of about 500 rpm. Samples are withdrawn from the vessel at frequent time intervals and analyzed for fluoride concentration by ion selective electrode and distillation method.

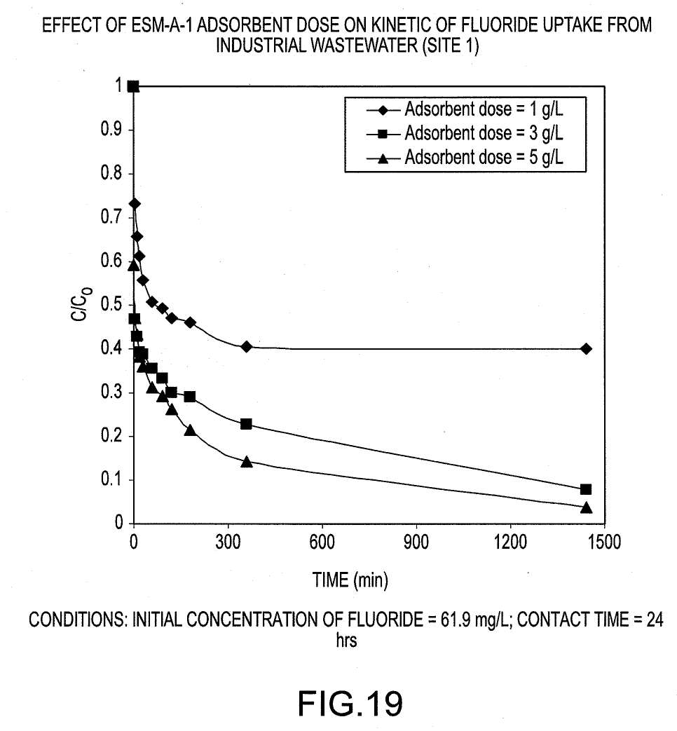

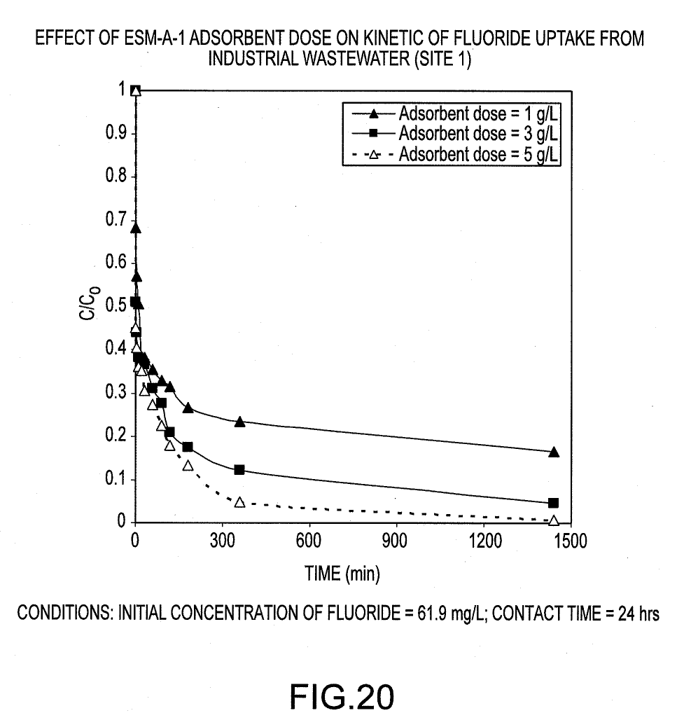

The kinetic studies provide the equilibrium time required for a sorption reaction as it describes the rate of solute uptake at the solid-solution interface. The sorption of fluoride by the ESM-A-1 adsorbent exhibits a biphasic uptake, as illustrated in FIGS. 19 and 20. The ESM-A-1 adsorbent exhibits a rapid uptake within the first 30 minutes for the three different initial adsorbent doses. This rapid removal is followed by a slow period, with no significant removal, indicating the attainment of equilibrium. The initial rapid uptake indicates surface bound sorption, and the slow second period due to the long-range diffusion of solute ions onto interior pores of the adsorbent.

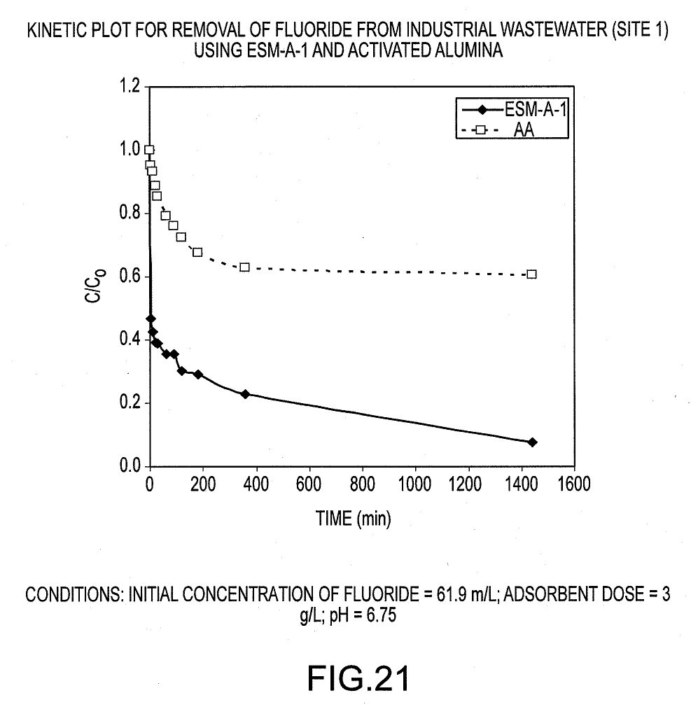

The kinetics of uptake of fluoride from SITE 1 wastewater using ESM-A-1 adsorbent and activated alumina is also studied. The kinetics of fluoride uptake by the ESM-A-1 adsorbent is faster than activated alumina, as illustrated in FIG. 21. Table 10, below, illustrates the fluoride concentration after the kinetic studies using the ESM-A-1 adsorbent by ion selective electrode method and distillation methods. The fluoride concentrations estimated by both methods are closely matching.

TABLE 10
Comparison fluoride analysis results using ion selective electrode
method with distillation method (Kinetics of fluoride from SITE 1
wastewater using ESM-A-1 adsorbent)

| Time | Fluoride concentration by | Fluoride concentration by |
|---|---|---|
| (min) | ion selective electrode method (mg/L) | distillation method (mg/L) |
| 5 | 31.9 | 38.1 |
| 120 | 21.0 | 23.6 |
| 1440 | 6.16 | 7.91 |

Conditions: Initial fluoride concentration of 63.3 ppm; adsorbent dose: 3 g/L; pH: 6.75

iii. Column Breakthrough Studies

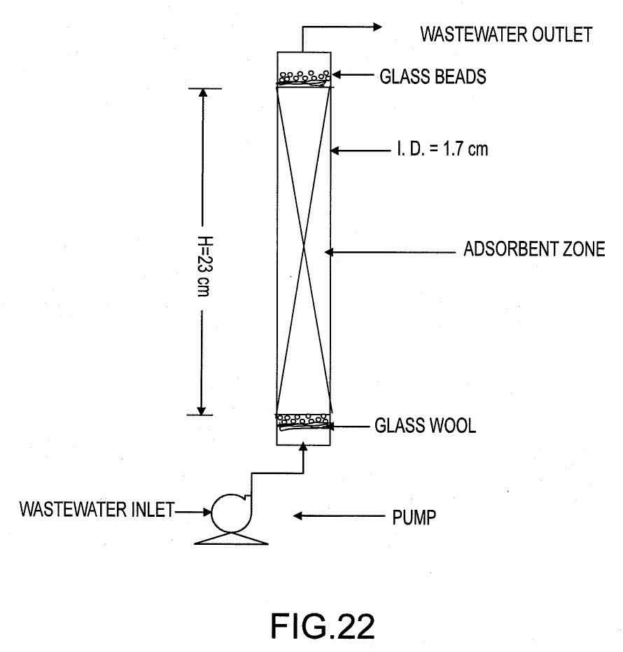

The ability of the ESM-A-1 adsorbent to remove fluoride from industrial wastewater is evaluated via continuous flow fixed bed column experiments using a PVC column having a length of 23 cm and an internal diameter of 1.7 cm. The experimental setup for these studies is illustrated in FIG. 22. The column is packed with the ESM-A-1 adsorbent (particle size 23-106 microns) and sand (particle size 0.6-2.0 mm) between two layers of glass wool at the top and bottom ends to prevent the absorbent from floating. The ESM-A-1 adsorbent and sand is used in a ratio of 30:70. Then, the column is continuously fed a fluoride containing wastewater at a volumetric flow rate of 5 ml/min using a peristaltic pump (Watson Marlow). Effluent samples are collected at pre-determined time intervals and analyzed for residual fluoride concentration. The adsorption column is operated until the fluoride concentration in the effluent exceeds 5 mg/l. A similar experiment is conducted with activated alumina.

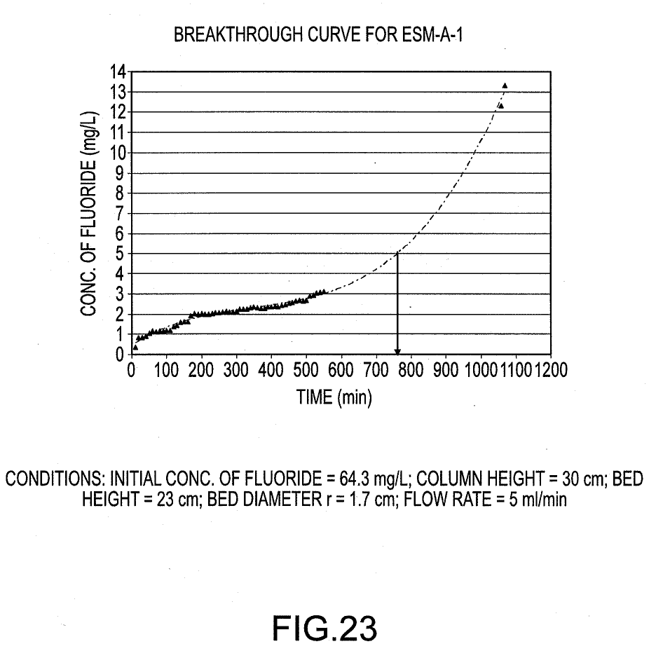

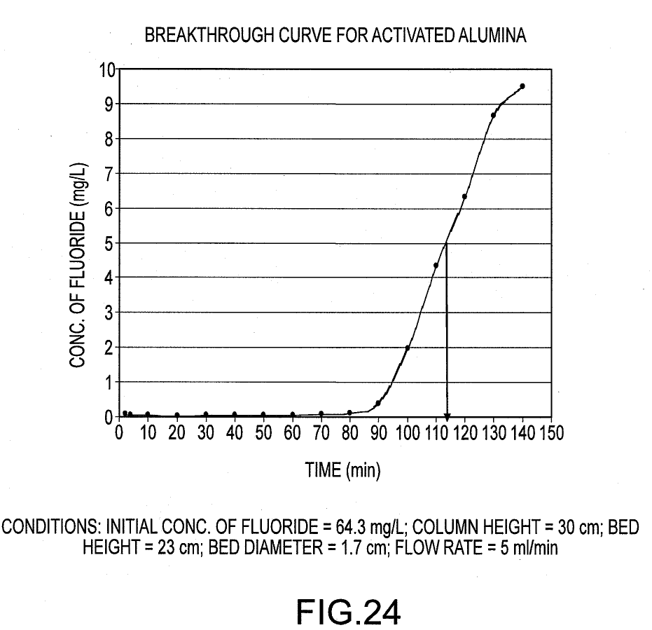

FIGS. 23 and 24 illustrate the breakthrough plot between Cₜ/Cₒ and breakthrough time for the ESM-A-1 adsorbent and activated alumina adsorbents. As illustrated, the ESM-A-1 adsorbent has a higher adsorption capacity compared to activated alumina. The breakthrough adsorption capacity for the ESM-A-1 adsorbent is nearly 9 times higher than that of activated alumina.

As illustrated in FIG. 24, at a lower contact time for activated alumina, the curve gradually rises, indicating gradual and continuous exhaustion of the activated alumina bed. As illustrated in FIG. 23, the ESM-A-1 adsorbent plot has a less gradual curve, only spiking towards the point of breakthrough, indicating a slower exhaustion of the bed and a higher adsorption capacity than activated alumina. Breakthrough results are provided in Table 11, below.

TABLE 11
Breakthrough time and breakthrough capacity for ESM-A-1
adsorbent and activated alumina

| | Breakthrough | Breakthrough |
|---|---|---|
| Adsorbents | time (min) | capacity (ml/g) |
| ESM-A-1 adsorbent | 775 | 291.35 |
| Activated alumina | 115 | 29.79 |

iv. Regeneration

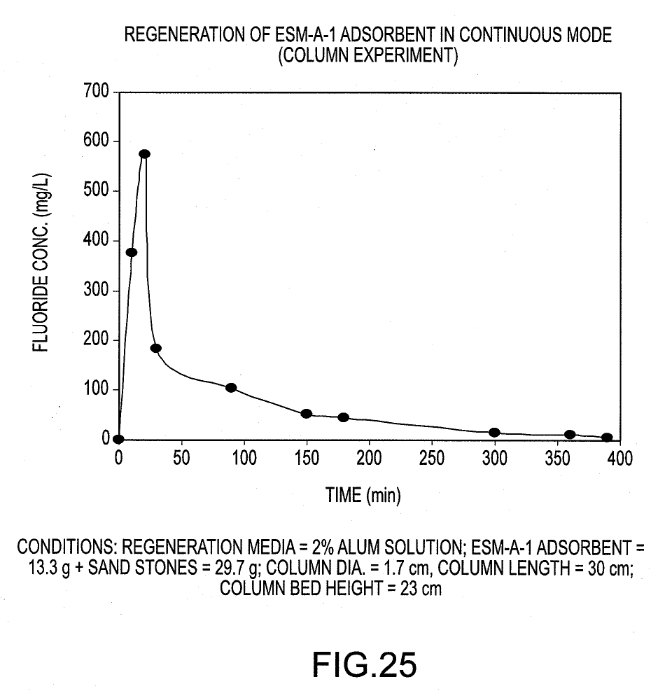

The ESM-A-1 adsorbent may be regenerated and reused in many cycles of operation (e.g., at least 5 cycles of operation). The desorption capacity of an ESM-A-1 based adsorbent is completed by subjecting the adsorbent to continuous repeat adsorption process using SITE 1 wastewater (fluoride concentration 61.9 mg/L). The exhausted ESM-A-1 adsorbent is regenerated using a 2% alum solution. FIG. 25 illustrates the desorption curve for fluoride and indicates that about 205 mg of fluoride, or 85% of the fluoride, is desorbed from the ESM-A-l adsorbent. The pH of the regenerate solution is found to be around 3 to 3.5.

### Example 2

### Chitin Based Adsorbents

A chitin based adsorbent is produced similar to the methodology illustrated in FIG. 4. In this example, the alumina loading is about 30%, the ratio of ES:chitin is about 1:1, the agitation time is about 4 hours, the calcining temperature is about 450° C., and the washing time is not greater than about 1 hour. This chitin based adsorbent is described in further detail below as “CBA-1”.

i. Breakthrough Column Studies—Batch-To-Batch Variability

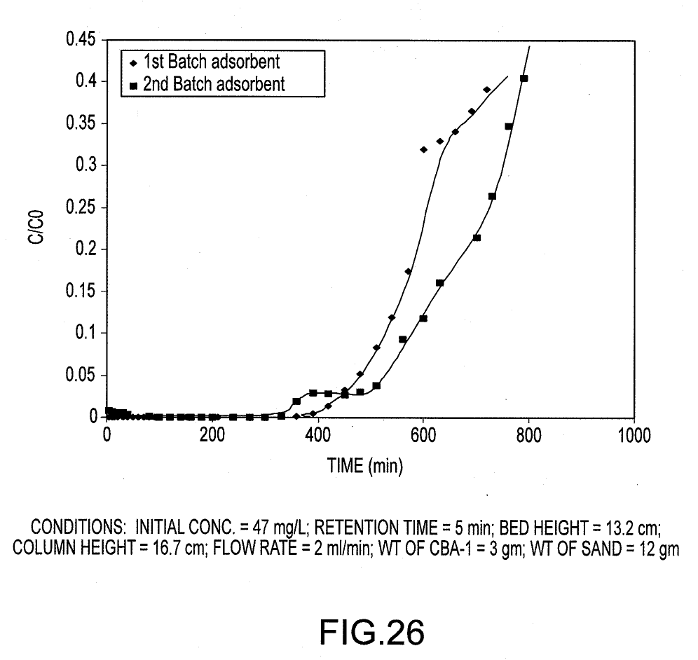

Breakthrough column studies are performed on CBA-1, the results of which are illustrated in FIG. 26. The experimental set-up is similar to that illustrated in FIG. 22 for ESM. These studies compare the fluoride removal performance between various batches of CBA-1. As provided by Table 12, below, the different batches realize similar fluoride breakthrough time with breakthrough capacities differing within ±10%, indicating good consistency and reproducibility between different batches, and also point towards a robust material synthesis protocol.

TABLE 12
Breakthrough column studies using chitin adsorbent media

| | Breakthrough | Breakthrough | Breakthrough |
|---|---|---|---|
| Adsorbents | time (min) | capacity (ml/g) | capacity (mg/g) |
| Batch-I: Chitin based | 540 | 360 | 16.53 |
| media | | | |
| Batch 2: Chitin based | 600 | 400 | 18.24 |
| media | | | |

Conditions: Initial fluoride concentration = 47 mg/L; adsorbent loading = 3 g/L; contact time = 24 hours

ii. Breakthrough Column Studies—CBA-1 v. ESM-A-1 v. Activated Alumina

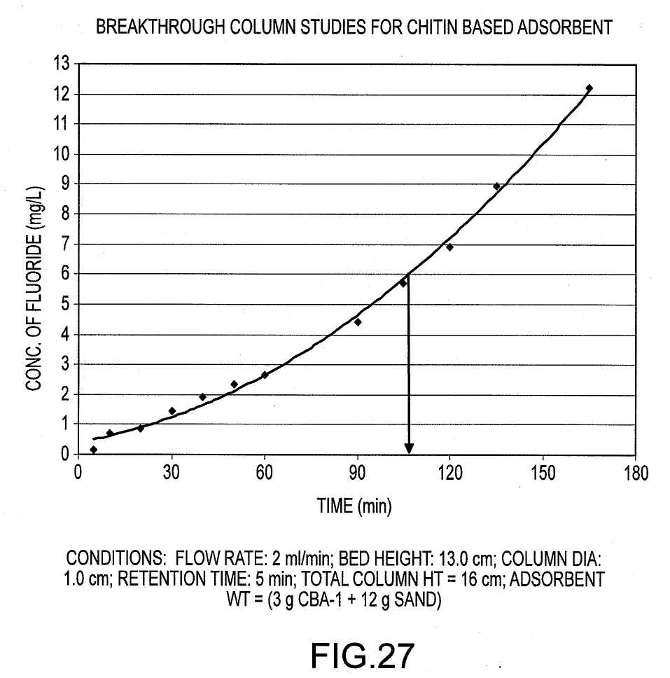

Column breakthrough studies of CBA-1 versus ESM-A-1 are completed. The CBA-1 column breakthrough performance is illustrated in FIG. 27, and the results relative to the ESM-A-1 are provided in Table 13, below.

TABLE 13
ESM-A-1 v. CBA-1 breakthrough comparison

| | Breakthrough | Breakthrough | Breakthrough |
|---|---|---|---|
| Adsorbents | time (min) | capacity (ml/g) | capacity (mg/g) |
| ESM-A-1 | 50 | 33.33 | 1.41 |
| CBA-1 | 110 | 73.33 | 3.13 |

Conditions: Flow rate = 2 ml/min; bed height = 13 cm; column diameter = 1.0 cm; retention time = 5 min; total column height = 16 cm; adsorbent weight = 3 g of CBA and 12 g of sand As illustrated, the CBA-1 generally performs better than the ESM-A-1 adsorbent.

iii. Additional Column Studies—CBA-1 v. ESM-A-1 v. Activated Alumina

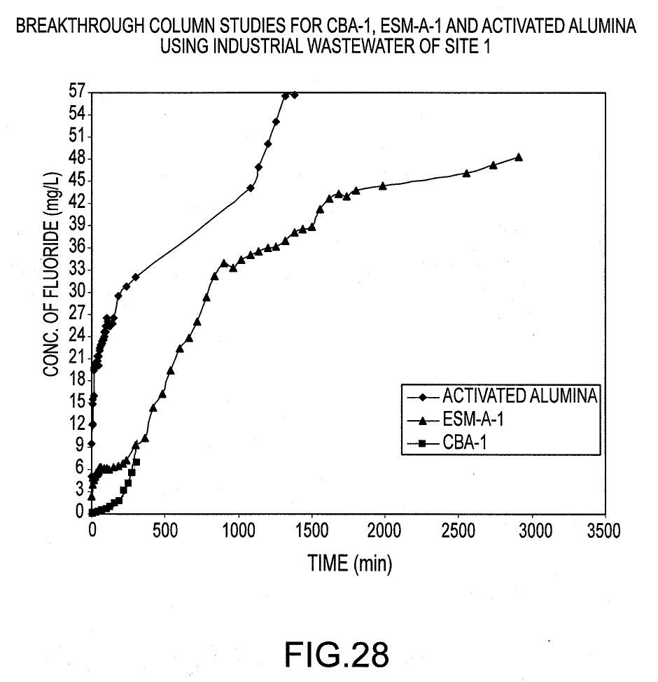

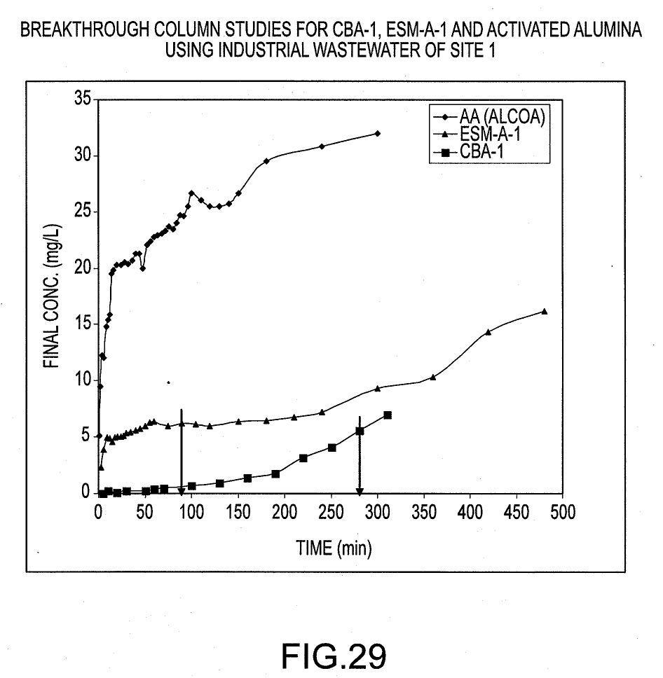

A comparison of activated alumina, ESM-A-1 and CBA-1 relative to fluoride removal is completed via column breakthrough studies and industrial wastewater. The results are illustrated in FIGS. 28-30. The CBA-1 media outperforms both the ESM-A-1 and activated alumina. The ESM-A-1 media outperforms the activated alumina.

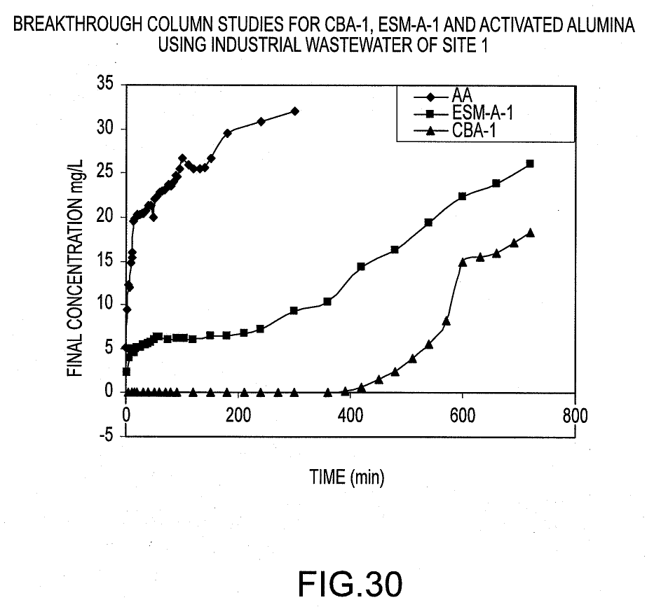

Some of these columns are operated at a typical hydraulic loading of 0.6 gpm/ft², but with a short retention of 5 minutes. Usually, empty bed contact time for this type of ex-situ technology employing a fixed bed column is in the range of 20-30 minutes. As illustrated in FIG. 30, even with a short retention time, the chitin based media outperforms both the activated alumina and the ESM-A-1 based media. As perspective, the breakthrough capacity (breakthrough concentration) in these tests is 6 mg/L, whereas the activated alumina is about zero (0) since near immediate breakthrough is achieved.

iv. Reproducibility of Adsorbent Production Methodology

CBA-1 is produced in accordance with the methodology of FIG. 4 and in increasing batch sizes. Each of the batches is tested for fluoride removal in industrial wastewater having an initial fluoride concentration of 47 mg/L, an adsorbent loading of 3 g/L and a contact time of 24 hours. The batch sizes and fluoride removal effectiveness is illustrated in Table 14, below.

TABLE 14
Increasing CBA-1 Batch Sizes

| Synthesis Batch | Yield (g) | Final fluoride conc. (mg/L) |
|---|---|---|
| Batch 1 | 3.17 | 2.63 |
| Batch 2 | 6.5 | 3.08 |
| Batch 3 | 9.7 | 2.73 |
| Batch 4 | 17.4 | 2.64 |
| Batch 5 | 33 | 2.94 |
| Batch 6 | 70 | 3.28 |

These results indicate that the methodology for production of CBA-1 is well-suited for scale-up and that the results are repeatable over various batch sizes.

v. XRD Analysis of CBA-1

An X-Ray diffraction (XRD) analysis of CBA-1 is completed. The XRD results are provided in Table 15, below. The analysis reveals the presence of alumina and various calcium compounds.

TABLE 15
XRD analysis results for CBA-1

| Peak | 2 Theta | Rel. Int. [%] | Catalog ID |
|---|---|---|---|
| 1 | 25.4432 | 100.00 | Alumina JCPDS 89-3072/ |
| | | | Calcium sulfate JCPDS 89-1458 |
| 2 | 31.3920 | 25.83 | Calcium carbonate JCPDS 87-1863 |
| 3 | 39.4499 | 13.78 | Calcium oxide JCPDS 17-0912 |
| 4 | 38.6700 | 13.49 | Calcium carbonate JCPDS 87-1863 |
| 5 | 40.8621 | 11.29 | Alumina JCPDS 89-3072 |
| 6 | 28.4372 | 10.76 | Calcium carbonate JCPDS 87-1863 |
| 7 | 48.7506 | 8.51 | Calcium oxide JCPDS 17-0912 |
| 8 | 52.3271 | 6.98 | Alumina JCPDS 89-3072 |
| 9 | 20.7358 | 6.88 | Calcium sulfate JCPDS 89-1458 |

CBA-1 is exposed to industrial wastewater and saturated with fluoride. An XRD analysis of the fluoride saturated CBA-1 media is completed, and the results are provided in Table 16, below. The fluoride saturated CBA-1 media is then regenerated via exposure to alum. Specifically, the media is contacted with a 2 wt. % alum solution for 70 minutes, followed by contact with a 5 wt. % alum solution for 70 minutes, followed by contact with fresh DI water. An XRD analysis of the regenerated CBA-1 media is completed, and the results are provided in Table 16, below.

TABLE 16
XRD analysis of fresh CBA-1, saturated CBA-1 and regenerated
CBA-1

| CBA-1 fresh | | CBA-1 F saturated | | CBA-1 regenerated | |
|---|---|---|---|---|---|
| | Rel. Int. | | Rel. Int. | | Rel. Int. |
| 2 Theta | [%] | 2 Theta | [%] | 2 Theta | [%] |
| 25.4432 | 100.00 | *29.4300 | 100.00 | #25.4505 | 100.00 |
| 31.3920 | 25.83 | *28.4666 | 49.83 | *29.4282 | 71.01 |
| 39.4499 | 13.78 | 39.4717 | 31.58 | #31.3469 | 27.38 |
| 38.6700 | 13.49 | 47.5970 | 29.17 | *28.4268 | 25.68 |
| 40.8621 | 11.29 | 35.9844 | 24.34 | #38.6489 | 15.05 |
| 28.4372 | 10.76 | *26.6372 | 22.87 | 11.6481 | 14.44 |
| 48.7506 | 8.51 | 48.5478 | 17.56 | *26.6278 | 13.94 |
| 52.3271 | 6.98 | 43.1721 | 10.21 | #40.8030 | 12.94 |
| 20.7358 | 6.88 | 36.6128 | 7.53 | #20.7210 | 11.53 |

The most intense (25.44) and several other peaks are regained (marked with #) after the regeneration, indicating that the adsorbent in nearly completely regenerated. However, the additional peaks (marked with *) generated during the fluoride adsorption are still present (though with lower intensity) in the regenerated media, indicating that small amounts of fluoride may still be present in the media.

vii. Batch Adsorption Studies of CBA-1

Batch adsorption experiments of CBA-1 are conducted to investigate the effect of various parameters like amount of adsorbent, initial concentration, contact time, presence of interfering ions and pH. The batch adsorption experiments are conducted in a manner similar to those conducted for ESM-A-1, described above.

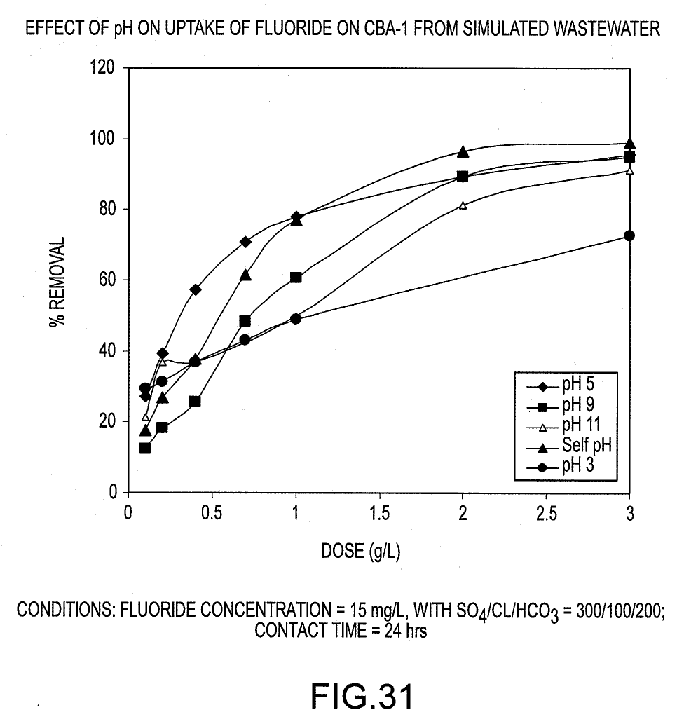

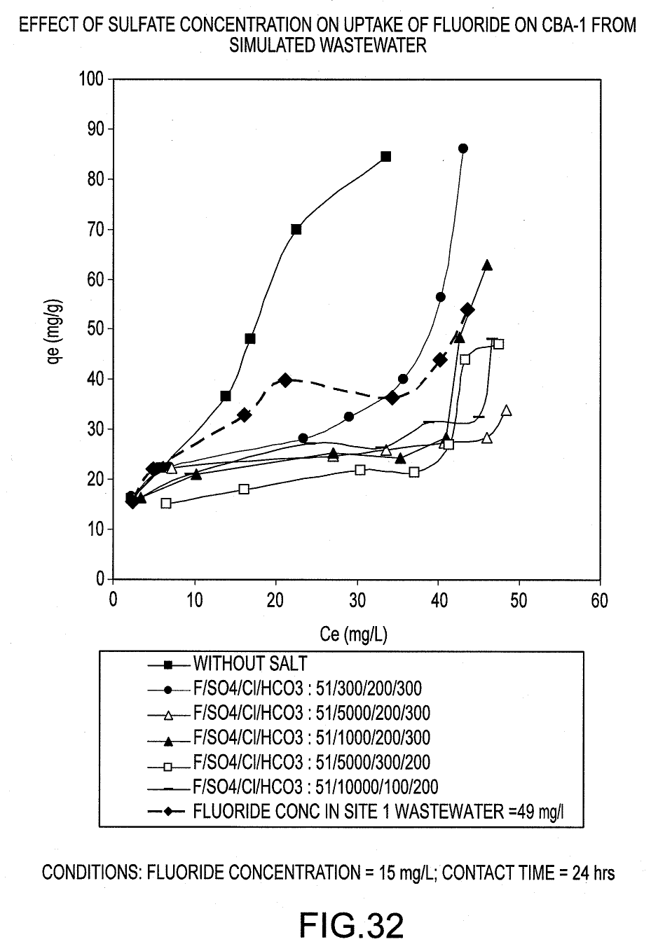

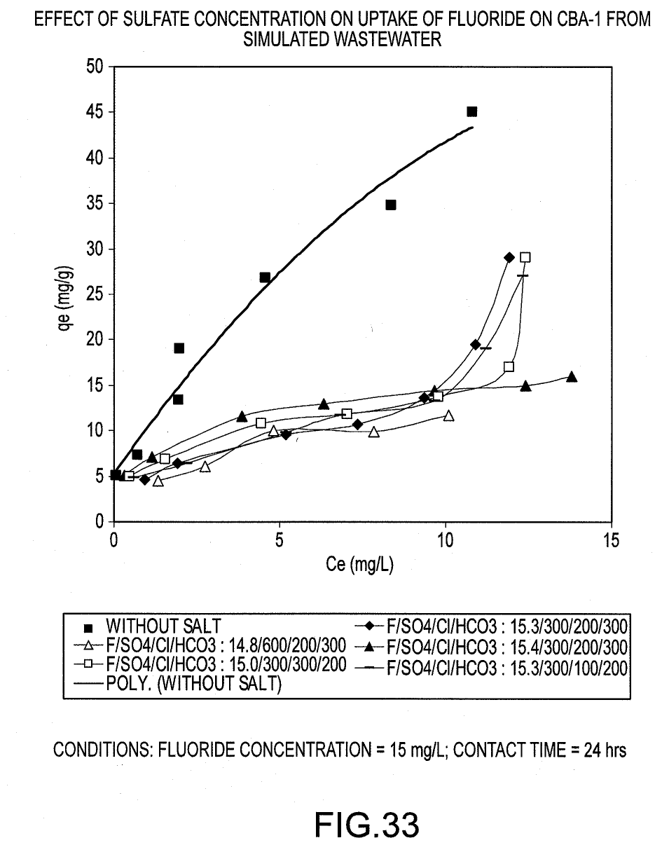

As illustrated in FIG. 31, the CBA-1 media is relatively insensitive to shifts in pH, achieving good fluoride removal rates in the pH range of 4-11, with the pH range of 5-9 realizing the best removal rates. Thus, it is possible to use the CBA-1 media to adsorb fluoride in water without adjusting pH, and it is possible to use the CBA-1 media in environments where pH adjustment is not possible. As illustrated in FIGS. 32 and 33, the CBA-1 media is also relatively insensitive to the presence of sulfate anions. Thus, it is possible to use the CBA-1 media to adsorb fluoride in water in the presence of relatively high amounts of sulfate anions.

While various embodiments of the present disclosure have been described in detail, it is apparent that modifications and adaptations of those embodiments will occur to those skilled in the art. However, it is to be expressly understood that such modifications and adaptations are within the spirit and scope of the present disclosure. For example, although wastewater has been utilized as the primary example of the utility of the bio-ceramic adsorbent, the bio-ceramic adsorbent may be utilized to remove fluoride from a variety of water types, including drinking water, surface water, storm water, non-potable water, and the like.

What is claimed is:

1. A method comprising:
(a) preparing a liquid mixture comprises at least one natural media, alum and a calcium source;
(b) recovering a bio-ceramic adsorbent from the liquid mixture, wherein the bio-ceramic adsorbent comprises an initial fluoride adsorption capacity, in water, of at least about 5 mg/g.

2. The method of claim 1, wherein the natural media is eggshell membrane, wherein the calcium source is eggshell, and wherein the bio-ceramic adsorbent comprises about 45-65 wt. % alumina, about 10-20 wt. % calcium oxide, about 5-15 wt. % sulfur, and about 1-5 wt. % carbon.

3. The method of claim 1, wherein the recovering step comprises:
(i) agitating the liquid mixture;
(ii) drying the liquid mixture and recovering a mass;
(iii) calcining the mass; and
(iv) washing the mass.

4. The method of claim 3, wherein the recovering step comprises:
(v) grinding the mass.

5. The method of claim 1, wherein the bio-ceramic adsorbent at least comprises a first phase and a second phase, wherein the first phase is a crystalline alumina phase, and wherein the second phase is an amorphous alumina phase.

6. The method of claim 1, wherein the natural media is chitin, and wherein the bio-ceramic adsorbent comprises about 15-35 wt. % alumina, about 20-40 wt. % calcium oxide, about 5-20 wt. % sulfur, and about 1-5 wt. % carbon

7. A bio-ceramic adsorbent produced from at least one natural media, the adsorbent comprising 15-65 wt. % of a metal oxide, 10-40 wt. % calcium oxide, 5-20 wt. % sulfur, and 1-5 wt. % carbon, wherein the bio-ceramic adsorbent comprises an initial fluoride adsorption capacity, in water, of at least about 5 mg/g.

8. The bio-ceramic adsorbent of claim 7, wherein the adsorbent is produced from at least two natural media, wherein the first natural media is at least one of eggshell membrane, chitin, and wherein the second natural media is a natural calcium support material.

9. The bio-ceramic adsorbent of claim 8, wherein the natural calcium support material comprises is eggshell.

10. The bio-ceramic adsorbent of claim 9, wherein the metal oxide comprises an aluminum oxide.

11. The bio-ceramic adsorbent of claims 10, wherein the bio-ceramic adsorbent comprises a crystalline phase and an amorphous phase, and wherein the crystalline phase comprises at least some aluminum oxide.

12. The bio-ceramic adsorbent of claim 11, wherein the crystalline phase comprises at least one of α-alumina, β-alumina, and γ-alumina.

13. The bio-ceramic adsorbent of claim 11, wherein the crystalline phase comprises both of α-alumina and β-alumina.

14. The bio-ceramic adsorbent of any of claim 7, wherein the bio-ceramic adsorbent is capable of removing fluoride from water, wherein the bio-ceramic adsorbent comprises an initial fluoride adsorption capacity of at least about 8 mg/g, wherein the initial fluoride concentration of the water is not greater than 100 mg/L.

15. The bio-ceramic adsorbent of claim 14, wherein the bio-ceramic adsorbent has a regenerated fluoride adsorption capacity that is at least 40% of the initial fluoride adsorption capacity.

16. The bio-ceramic adsorbent of claim 14, wherein the initial fluoride adsorption capacity is achievable in the presence of at least about 500 mg/L of sulfate anions.

17. The bio-ceramic adsorbent of any of claim 16, wherein the initial fluoride adsorption capacity is achievable when the water has a pH of from about pH 4 to about pH 9.

18. The bio-ceramic adsorbent of claim 17, wherein the bio-ceramic adsorbent comprises a specific surface area of not greater than about 30 m² per gram.

19. The bio-ceramic adsorbent of claim 18, wherein the bio-ceramic adsorbent has a bulk density of at least about 1.00 g/cm³.

20. An adsorbent produced from at least one natural media, the adsorbent comprising α-alumina and β-alumina, wherein the adsorbent is capable of removing fluoride from water, wherein the adsorbent comprises an initial fluoride adsorption capacity of at least about 5 mg/g, wherein the initial fluoride adsorption capacity is achievable in the presence of at least about 500 mg/L of sulfate anions, and wherein the initial fluoride adsorption capacity is achievable when the water has a pH of from about pH 4 to about pH 9.
